(19) United States
(12) Patent Application Publication
(10) Pub. No.: US 2025/0335252 A1
(43) Pub. Date: Oct. 30, 2025

(54) Method for Scheduling Multi-Model AI Workloads onto Multi-Chiplet Modules

(71) Applicant: The Regents of The University of California, Oakland, CA (US)

(72) Inventors: Mohammad Abdullah Al Faruque, Irvine, CA (US); Mohanad Odema, Irvine, CA (US); Luke Chen, Irvine, CA (US); Hyoukjun Kwon, Irvine, CA (US)

(73) Assignee: The Regents of The University of California, Oakland, CA (US)

(21) Appl. No.: 19/187,367

(22) Filed: Apr. 23, 2025

Related U.S. Application Data
(60) Provisional application No. 63/640,496, filed on Apr. 30, 2024.

(51) Int. Cl. G06F 9/50

(52) U.S. Cl. CPC G06F 9/5027

(57) ABSTRACT

We disclose a scheduler that thoroughly considers heterogeneous multi-chiplet module (MCM) and multi-model workloads, which employs advanced scheduling techniques, such as inter-layer pipelining and dynamic chiplet regrouping utilizing latest representations such as resource allocation trees.

### PRIORITY APPLICATION

This application claims the benefit of U.S. Patent Application No. 63/640,496, entitled “METHOD FOR SCHEDULING MULTI-MODEL AI WORKLOADS ONTO MULTI-CHIPLET MODULES,” filed on Apr. 30, 2024 (Attorney Docket No. UCI1003USP01). The provisional patent application is incorporated by reference for all purposes.

### FIELD OF THE TECHNOLOGY DISCLOSED

The technology disclosed targets both the semiconductor and artificial intelligence (AI) technologies. For the former, the technology disclosed comes as a byproduct of the semiconductor's industry post-Moore era and slowing down of Dennard's scaling that has ushered in the era of chiplet-based systems design so as to maintain the scalability levels required to handle the rising compute demands from emerging artificial intelligence (or AI) workloads. For the latter, emerging AI workloads are characterized by being large in scale and compute demands, as in datacenter workloads running multiple AI models simultaneously on shared resources, or augmented reality (AR) and virtual reality (VR) systems running multiple dependents and dynamic workloads with intricate dependencies also on shared resources. As such, the technology disclosed aims to provide an end-to-end scheduling and hardware reconfigurability tool to automate and optimize the scheduling of emerging AI workloads onto heterogeneous multi-chiplet module systems to enhance performance efficiency with regards to latency, energy consumption, and throughput.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

### DESCRIPTION OF RELATED ART

Emerging multi-model workloads with heavy models such as recent large language models have significantly increased the compute and memory demands on hardware. To address such increasing demands, designing a scalable hardware architecture became a key problem. Among recent solutions, the 2.5D silicon interposer multi-chip module (MCM)-based AI accelerator has been actively explored as a promising scalable solution due to their significant benefits in the low engineering cost and composability. However, existing MCM accelerators are based on homogeneous architectures with fixed dataflow, which encounter major challenges from highly heterogeneous multi-model workloads due to their limited workload adaptivity.

Therefore, an opportunity arises to develop systems and methods that address challenges in scheduling multi-model workloads on heterogeneous multi-chiplet module (MCM) AI accelerators.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIGS. 1A, 1B, 1C and 1D illustrate an architectural-level schematic of a system in accordance with one implementation of the technology disclosed.

FIG. 1E presents a process flow diagram illustrating process operations for the proposed two-level scheduling of multi-model workloads on heterogeneous multi-chiplet module (MCM) AI accelerators.

FIG. 2 shows one implementation of the disclosed scheduling technology.

FIG. 3 presents a table illustrating notation used in formulation of the proposed scheduling technology.

FIG. 4A presents an implementation of proposed two-level scheduling framework for multi-model workloads on heterogeneous multi-chiplet module (MCM) AI accelerators.

FIG. 4B. presents another implementation of proposed two-level scheduling framework for multi-model workloads on heterogeneous MCM.

FIG. 5 presents one implementation of the disclosed layer assignment algorithm.

FIG. 6 presents another implementation of the disclosed layer assignment algorithm.

FIG. 7 presents one implementation of the disclosed resource provisioning algorithm.

FIG. 8 presents schedules creation through the segmentation engine (SEG) and scheduling engine (SCHED). The scheduling engine (SCHED) space is modeled by a set of trees.

FIG. 9 presents MCM microarchitecture parameters in a tabular form, scaled to 28 nm process node technology.

FIG. 10 presents multi-model workload scenarios for datacenter and augmented reality and virtual reality (AR/VR) use cases in a tabular format.

FIG. 11 presents graphical illustrations of the evaluated MCM chiplet organizations using the technology disclosed.

FIG. 12 presents latency, energy and energy-delay product (EDP) evaluations for top-scoring 3×3 candidates normalized by a standalone NVIDIA deep learning accelerator (NVDLA) for datacenter scenarios.

FIG. 13 presents a breakdown of the search results across various datacenter scenarios from the table presented in FIG. 10.

FIG. 14 presents Pareto results for the brute force search across various MCM strategies on various search targets for scenarios 4 and 5 from the table in FIG. 10.

FIG. 15 presents top-scoring scheduling strategy for Scenario 4 Het-Sides including allocation of chiplets and coarse-grained schedules for each time window.

FIG. 16A includes a table presenting EDP search AR/VR results and graphs illustrating evaluations on the EDP search for the XR Bench usage scenarios normalized by NVDLA standalone configuration.

FIG. 16B presents Pareto optimal results on the EDP search experiments for the labeled XR Bench usage scenarios.

FIG. 16C presents graphs illustrating results for the EDP search for scenarios 3 and 4 on the Triangular network-on-package or NoP topologies from FIG. 11.

FIG. 17 presents end-to-end latency breakdown in seconds for the top partitioning candidate in FIG. 15.

FIG. 18 presents Pareto plot and comparison of top performing models for the EDP search.

FIG. 19 includes a table presenting a comparison of the technology disclosed with prior related scheduling techniques.

FIG. 20 shows an example computer system that can be used to implement the technology disclosed.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should betaken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### Introduction

Recent artificial intelligence (AI) inference workloads have increased their scale in both of the model size (e.g., large language models) and the number of models deployed together (e.g., augmented reality and virtual reality; AR/VR), which constructs multi-model workloads with heavier models than those in the past. Such trends led to heavy demands on compute capabilities in AI hardware from edge to cloud devices. As an approach to scale up the hardware for AI and increase the compute capability, chiplet-based multi-chip module (MCM) package has emerged as a promising solution. Such MCM packages facilitate the scaling of AI hardware based on their composability and cost-effectiveness, unlike monolithic designs, which are often constrained by fabrication yields, power, heat, and other engineering costs such as verification. A chiplet is a tiny integrated circuit (IC) that contains a well-defined subset of functionality. It is designed to be combined with other chiplets on an interposer in a single package to create a complex component such as a multi-chip module (or MCM). Unlike traditional monolithic chips, which integrate all functionalities into a single silicon die, chiplets break down these functionalities into smaller, specialized dies. The chiplets are then interconnected within a single package or a module, allowing for greater flexibility, efficiency, and scalability in chip design.

Researchers have actively explored the MCM for AI, focusing on the dataflow mapping (i.e., loop ordering, parallelization, and tiling) of each layer and workload orchestration onto chiplets considering the network-on-package (NoP) and other communication constraints. For example, Simba proposed a scalable MCM inference architecture that enables chiplets to either act as standalone inference engines or collaborate as groups for a layer. Although such works have successfully delivered promising performance and energy efficiency than monolithic designs, they mostly focused on single-model workloads targeting homogeneous chiplets. Unlike single-model workloads, multi-model workloads introduce major challenges to such homogeneous MCMs because of the machine learning (or ML) operator heterogeneity (e.g., operator types and tensor sizes) and resulting diverse dataflow preferences. Also, multi-model workloads often involve model level dependency and concurrency which adds complex considerations to the scheduling problem.

Therefore, considering the new trend with multi-model AI workloads in industry, such as multi-tenancy and AR/VR, we explore heterogeneous chiplet-based MCM with AI accelerator chiplets with various dataflows, as a future-proof option. To exploit the benefits of heterogeneous MCM accelerators, we consider inter-layer pipelining to enhance in-package data reuse and reduce offchip traffic. We formulate the scheduling problem and develop effective heuristics to navigate the huge scheduling space, whose problem scale is as big as O(10⁵⁶) even for a two-model workload (e.g., ResNet-50 and UNet) on a 6×6 chiplet MCM AI accelerator system (as in Simba).

We evaluate ten MCMs including seven heterogeneous MCM son ten multi-model scenarios: the first five scenarios are curated using ML Perf inference benchmark representing datacenter multi-tenancy scenarios. The models are selected based on recent datacenter model usage trends and the trend of language model adoptions (e.g., GPT-L), future-proofing emerging AI workloads such as AI assistant. The other five scenarios are curated for AR/VR usage scenarios from XR Bench as a practical use case for edge multi-model workloads.

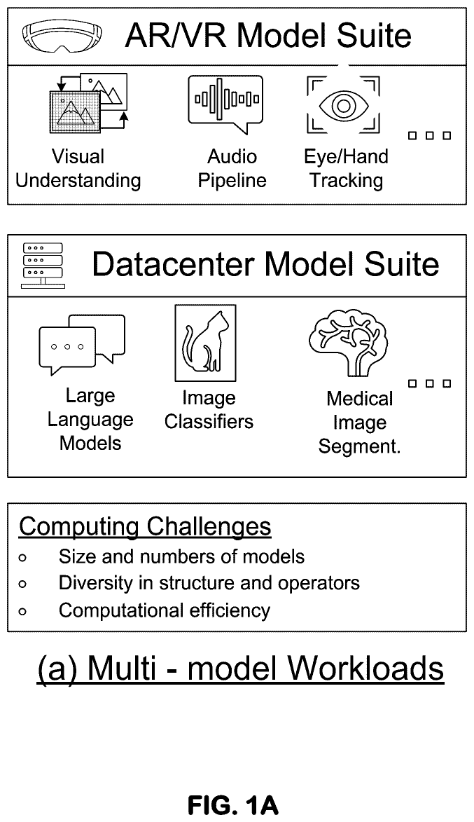

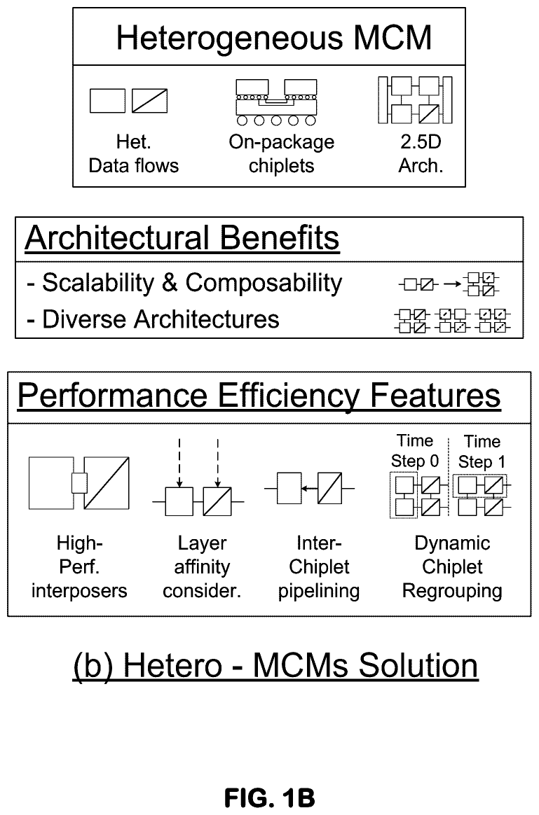

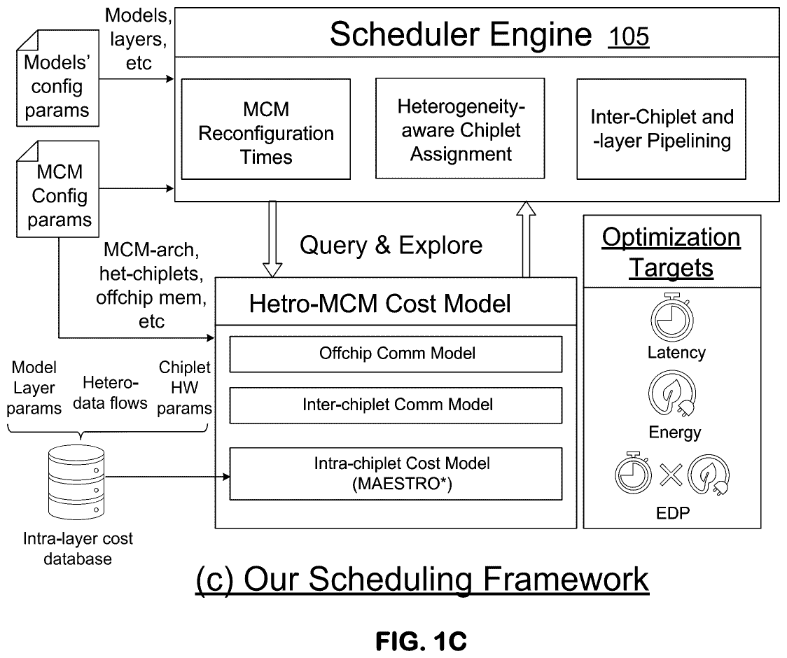

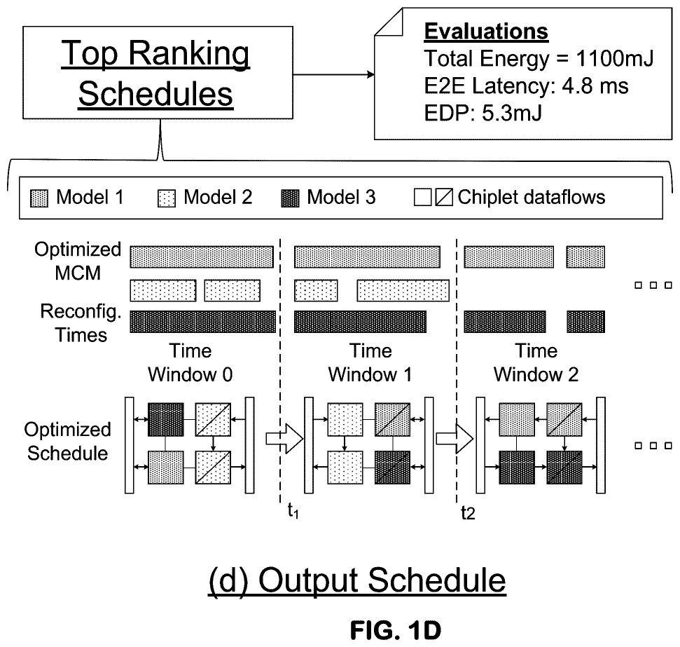

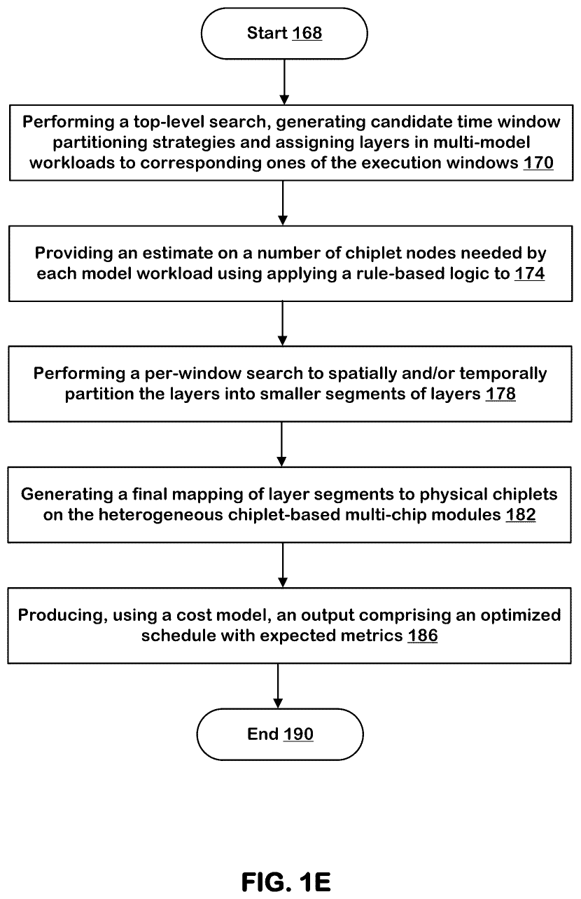

The evaluation results show that heterogeneous MCM combined with our scheduling method is promising for heavy multi-model workloads, which is projected by recent trend. Compared to the homogeneous MCM running NVDLA and Shidiannao style dataflows, heterogeneous MCM, on average, achieved 27.6% and 29.6% less energy-delay product (EDP) in each domain, respectively. We also showcase that our scheduler technology includes logic that can identify schedules that can reduce EDP to 0.3× (or 0.3 times) that of single-model schedulers like NN-baton. Selected features of the scheduler technology disclosed herein are presented below:
As a promising future-proof architecture for heavy multi-model workloads, the scheduler technology can handle heterogeneous dataflow MCM for emerging AI workloads with multiple models running concurrently.
We formulate the MCM AI accelerator scheduling problem into a multi-tiered optimization problem to address intractably large scheduling space.
Based on the formulation, we disclose a scheduler engine 105 (also referred to as a scheduler), as shown in FIG. 1C, that thoroughly considers heterogeneous MCM and multi-model workloads. The scheduler employs advanced scheduling techniques (inter-layer pipelining, dynamic chiplet regrouping) with resource allocation tree representation.
We codify our scheduling method and integrate it with a heterogeneous MCM AI accelerator cost model. The technology disclosed can enhance or extend existing technologies. For example, present an example extension of MAESTRO to model the latency and energy of MCM accelerators.
We analyze the costs and benefits of heterogeneous dataflow MCM using industry use case-inspired multi-model workloads and present the importance of the scheduling problem.

FIGS. 1A, 1B, 1C and 1D present an overview of the technology disclosed and identifies various engines, components of the framework for scheduling multi-model AI workloads. FIG. 1A provides a background and motivation for development of the technology disclosed. It shows that emerging multi-model workloads have introduced new challenges for artificial intelligence (or AI) hardware. FIG. 1B graphically illustrates that MCMs present a promising solution to scale with multi-model workloads with some considerations. FIG. 1C presents a high-level architecture of the disclosed scheduling framework that addresses the challenges to explore the heterogeneous scheduling space. FIG. 1C also presents a high-level architecture of the scheduler engine (also referred to as a scheduler) 105. FIG. 1D presents a graphical illustration of output schedule provided by the disclosed scheduling framework. The output schedule provides optimized spatiotemporal scheduling strategies for the multi-model workloads. Further details of the technology disclosed are presented below.

### A. Multi-model AI Workloads

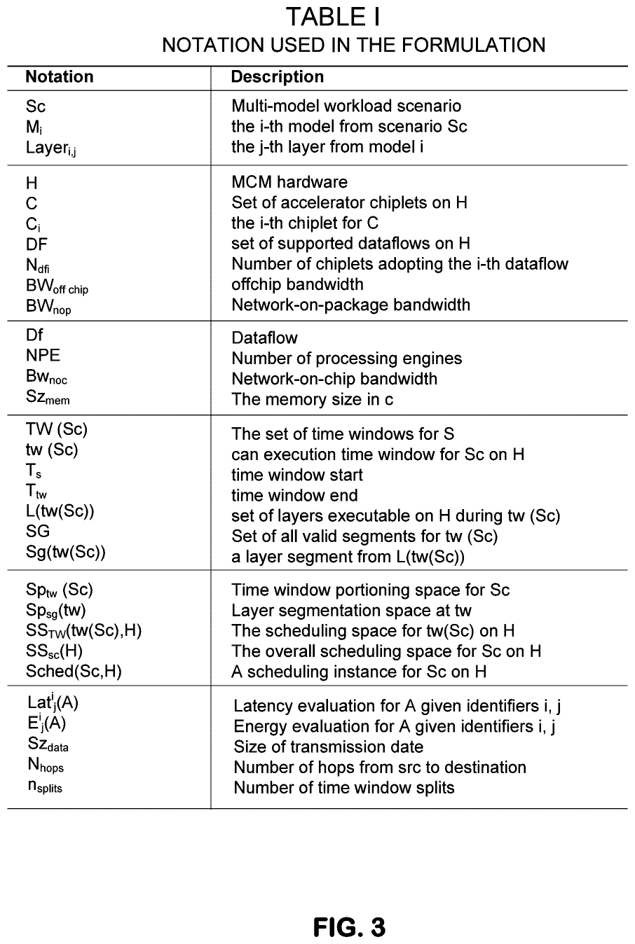

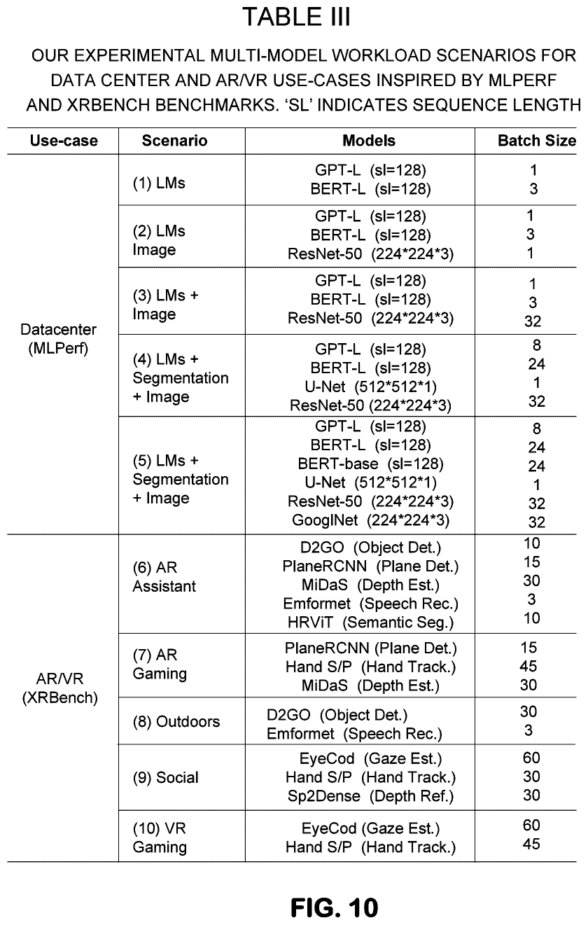

Multi-model AI Workloads. The success of AI algorithms in individual tasks (e.g., hand tracking, depth estimation, speech recognition) led to the emergence of multi-model AI workloads, which include multi-tenant workloads at data centers and real-time multi-model workloads such as for augmented reality and virtual reality (AR/VR). We summarize example multi-model AI workloads from industrial use cases presented in a table in FIG. 10. The table in FIG. 10, labeled as Table III presents experimental multi-model workload scenarios for datacenter and AR/VR use cases. A total of ten scenarios labeled from (1) to (10) are presented in the scenario column in the table in FIG. 10. A label “SL” or “sl” in the table in FIG. 3 indicates sequence length. The models in such workloads are diverse in terms of the tasks and input modalities. For example, an industrial data center multi-tenant AI workload suite includes a face recognition model based on support vector machine, recommendation models based on multi-layer perceptron, and a speech recognition model based on recurrent neural network (RNN). More recent workloads in data center AI workload include large language models, which adds more heterogeneity to the multi-model AI workloads. Such multi-model workloads involve high heterogeneity in AI operators (or layers), which is one of the major challenges to accelerators that specialize the architecture and dataflow for a specific set of workloads.

B. Scheduling AI workloads on AI Hardware and MCMs

Scheduling AI workloads considers the assignment of computations (e.g., model, layer, or tile) to target hardware platforms and their constituent computing units. Further details of AI workloads scheduling practices and technologies are presented below.

Scheduling on CPU/GPU systems. modern systems (such as servers) typically employ GPUs and/or CPUs for inference services. Most of these computing units are based on homogeneous cores—or simple heterogeneity such as big and little cores in CPUs (central processing units), or CUDA (compute unified device architecture) and Tensor cores in GPUs (graphics processing units). Traditionally, scheduling in such settings is concerned with the coarse assignment of models to computing units, leaving the operator assignments to be performed in a direct manner (e.g., all GEMM or general matrix multiplication operations to Tensor Cores in a GPU). As multi-model workloads proliferated, new features (e.g., GPU sharing) emerged to improve inference services for small-batch inference tasks. Still, the limited programmer/compiler control and the cache-based memory systems restrict CPUs/GPUs from engaging multi-model workload scheduling on a finer granularity.

Scheduling on customized AI accelerators. Customized AI accelerators (such as GOOGLE™ TPU or META™ MTIA) enable full programmer/compiler control over memory operations (e.g., when and what to read/write, when and what to evict, etc.). AI accelerators typically employ scratchpad memory-based systems to support deterministic low-level activities. AI accelerators are also integrated into edge hardware (e.g., NPU in Apple Vision Pro's M2 chip).

Scheduling on MCM AI Accelerators. To scale with the rising compute demands of modern AI workloads, multi-chip modules (MCMs) have emerged as viable approach enabling the integration of composable, small functional dies (chiplets) on the package level to build a larger system, where they are connected together via on-package links typically through silicon interposer or organic substrates to create a network-on-package (NoP). Through enabling scalability via adjusting the number of chiplets on the package, as well as low verification costs, many chiplet-based systems have been developed for scalable deep learning inference:

Simba MCM system comprises 36 chiplets, each containing 16 processing engines to deliver up to 128 TOPs computing capability. Another example is TESLA™ DOJO chiplet-based architecture capable of scaling to exaFLOP supercomputers for large-scale machine learning. The scaling in chiplet sizes, architectures, and computational capabilities has enabled support for serving multi-model workloads together on the same MCM system with a finer degree of scheduling granularity (operator, tiles). However, multi-model schedulers face new challenges compared to their single-model counterparts considering the increased memory footprints, bandwidth contention, etc.

### Process for Scheduling Multi-Model AI Workloads

FIG. 1E presents a process flow diagram (also referred to as a process flow chart) illustrating process steps or operations for scheduling multi-model AI workloads. As with all flow diagrams (or flow charts) herein, it will be appreciated that many of the operations can be combined, performed in parallel or performed in a different sequence without affecting the functions achieved. In some cases, as the reader will appreciate, a re-arrangement of operations will achieve the same results only if certain other changes are made as well. In other cases, as the reader will appreciate, a re-arrangement of operations will achieve the same results only if certain conditions are satisfied. Furthermore, it will be appreciated that the process flow diagram in FIG. 1E shows only operations that are pertinent to an understanding of the technology, and it will be understood that numerous additional operations for accomplishing other functions can be performed before, after and between those shown.

The process starts an operation 168. The method includes performing a top-level search executed by a reconfiguration engine configured with a window assignment logic. The window assignment logic is based on expected execution latencies of layers in the multi-model workloads. The window assignment logic generates candidate time window partitioning strategies by sampling a set of discrete points in time reflecting boundary points between execution windows and assigns the layers in the multi-model workloads to corresponding ones of the execution windows (operation 170). The multi-model workloads can correspond to workloads of multiple artificial intelligence models. Each of the multiple artificial intelligence models has a plurality of layers. The description files of the multi-model workloads specify at least one of layer parameters, a layer topology, layer dependencies, and an expected latency and energy of each layer on each chiplet as analyzed offline. The description files of the hardware specification of the heterogeneous chiplet-based multi-chip modules specify at least one of a number of chiplets, a shape of chiplet arrays, a dataflow organization of the chiplet arrays, network-on-package (NoP) bandwidth, and on-chiplet memory size. The expected execution latencies of the layers can be estimated using average latency for each chiplet type with a unique dataflow organization in the heterogeneous chiplet-based multi-chip modules. The window assignment logic can assign the layers to corresponding ones of the execution windows based on a first-fit heuristic.

The method includes providing an initial estimate on a number of chiplet nodes needed by each model workload in each execution window given a candidate partitioning strategy (operation 174). The method includes applying a rule-based provisioning logic to provide the initial estimate as described above in operation 174. The rules used by the rule-based provisioning logic can be based on expected latency, energy, and energy-delay product (EDP). The rules can be based on user-defined metric for each corresponding execution window. The rule-based provisioning logic warrants a fair spatial distribution of the chiplet nodes per execution window across the model workloads. The rule-based provisioning logic is agnostic to a dataflow of underlying chiplets in the heterogeneous chiplet-based multi-chip modules.

The method includes performing a per-window search executed by a segmentation engine configured to spatially and/or temporally partition the layers into smaller segments of layers. Each of the segments are mappable to a chiplet for exclusive execution throughout the duration of an execution window (operation 178). In one implementation, the smaller segments of layers are segments. In another implementation, the smaller segments of layers are tiles.

The method includes generating a final mapping of layer segments to physical chiplets on the heterogeneous chiplet-based multi-chip modules by using a scheduling logic (operation 182). In one implementation, the segments are executable in a layer-sequential manner that executes a particular segment's sequence of layers on the allocated chiplet. In another implementation, the segments are executable in a layer-pipelining that executes inter-layer and inter-chiplet pipelining between different segments conditioned on their dependencies. The scheduling logic is further configured to generate the final mapping based on exploring a scheduling search space that encapsulates scheduling candidates capturing true physical properties of the heterogeneous chiplet-based multi-chip modules. In one implementation, the true physical properties include at least one of heterogeneity pattern, offchip memory access, and NoP topology.

The method includes producing, using a cost model, as output, an optimized schedule with expected metrics (operation 186). In one implementation, the expected metrics include latency, energy, or EDP. The expected metrics can be user-defined metrics based on a combination of latency and energy. The process ends at an operation 190.

We now present further details of the disclosed scheduling technology using examples as presented below.

### C. Motivational Example

We now present the technology disclosed using various examples. Consider the NN-baton as a baseline scheduler as it targets scheduling single model workloads on multi-chiplet accelerators. NN-baton proposes to partition a single model workload across several chiplets whenever its computational demands exceed a single chiplet's capacity, and employs a unified dataflow across the chiplets. As heterogeneous accelerators proliferate, chiplets technology has facilitated their integration on the package level. Consider a small heterogeneous 2×2 MCM containing 3 NVDLA-like (weight stationary) and 1 Shidiannao-like (output stationary) accelerators, and consider a small multi-model workload constituting 3 layers from the second ResNet-50 block and one fully connected layer from GPT-L. We analyze the schedules yielded through NN-baton and our scheduler as follows.

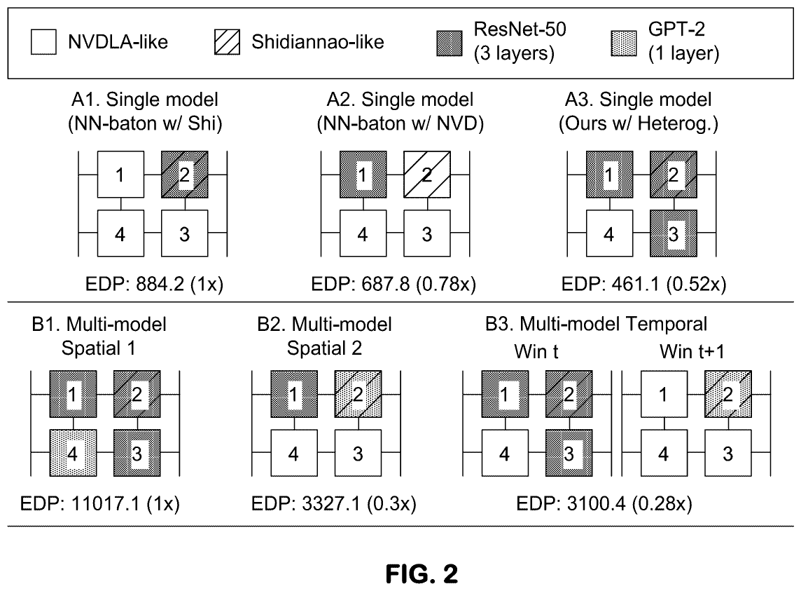

Single model case. We show the single model scheduling results for the ResNet-50 workload labeled as A1, A2 and A3 in FIG. 2. FIG. 2 presents results of a motivational experiment on a 2×2 MCM AI accelerator using batch size of one for three layers from the second ResNET-50 block and the first feed forward layer from GPT-2. Each chiplet has 4096 Pes and 10 MB L2 shared memory. Existing scheduling technologies (such as NN-baton) consider partitioning computation across chiplets only when not enough resources exist. As each chiplet possess sufficient resources to process the ResNet-50 workload, NN-baton schedules the workload onto a single chiplet. As shown, scheduling the ResNet-50 workload to the NVDLA-like chiplet (A2) experiences 0.78× the EDP as that from the Shidiannao-like chiplet (A1). However, a more nuanced schedule (A3) identified through our scheduler leverages heterogeneity by distributing the ResNet-50 layers across the heterogeneous chiplets, sustaining 0.52× less EDP than (A1) through catering to individual layer affinities.

Multi-model case. We now describe graphical illustrations labeled as B1, B2 and B3 in FIG. 2. The illustration B1, NN-baton (B1) is agnostic to the heterogeneous MCM composition, executing each model workload sequentially on its starting chiplet 1. We show two schedules that are sampled through our schedules:
(i) In (B2), the disclosed scheduler (also referred to as scheduling engine) can spatially distribute the ResNet-50 and GPT-2 workloads across the NVDLA-like and Shidiannao-like accelerators, respectively, leading the EDP to be 0.3× that in (B1).
(ii) In (B3), the disclosed scheduler (also referred to as scheduling engine) recognizes a spatiotemporal optimization to leverage the heterogeneous chiplet pipelining for the ResNet-50 in one time window, and then schedule the GPT-2 layer on the Shidiannao layer in the following time window, leading EDP to be 0.28× that of (B1).

### D. Complexity of the Multi-Model Scheduling Space

To understand the scale of the multi-model scheduling problem, we analyze its search space complexity. Let a multi-model workload constitute N models, each model containing Li layers, and L=NL. Let C be the total number of accelerator chiplets on an MCM. Then, a characterization of the multi model scheduling space can be given as

$$O ( {C}^{L} \times \frac{L}{{L}_{1} ! {L}_{2} ! … {L}_{N}} )$$

The first term covers the set of possible chiplet assignments for each layer (spatial complexity); whereas the multinomial coefficient

$$( \frac{L}{{L}_{1} ! {L}_{2} ! … {L}_{N}} )$$

covers the number of ways to interleave multiple sequences of layers, while maintaining the layer dependencies for each model. In the motivational example above, this complexity accounts for a total of O(1536) scheduling possibilities. If we consider a more practical case involving a ResNet-50 and UNet models (L1=50 and L2=23) on a full Simba system (C=36), the complexity becomes ˜O(10⁵⁶), showcasing an exponential rise as the models grow in number and complexity.

### E. Summary on the Challenges of Multi-Model Scheduling

We summarize the unique scheduling challenges for multi-model workloads compared to their single-model counterparts:
Layer sequence permutations: In a single model scenario, the space of computation assignments is defined based on dependent layer sequences from a single model. Whereas in a multi-model scenario, independent layer sequences from different models also exist, compounding the decision space complexity as a result of permutations.
Spatial mapping conditioning: The quality of one model's schedule is affected by the spatial mappings of other models' mappings due to resource availability, bandwidth contention, added data travel times, and so on.
Heterogeneous Integration Trade-offs: Performance efficiency depends on the underlying pattern of heterogeneous integration, and the diversity within and across model workloads imply that no single pattern fits all.

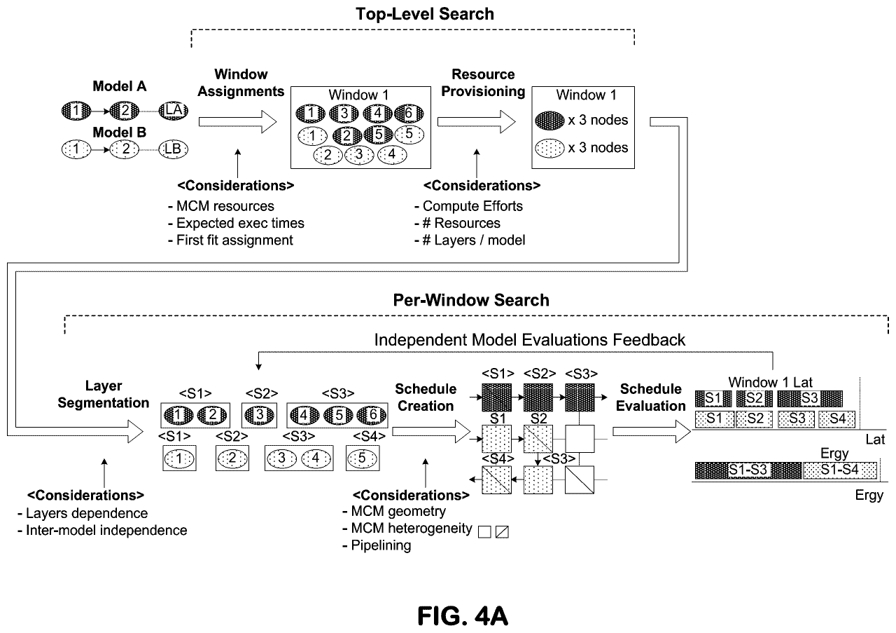

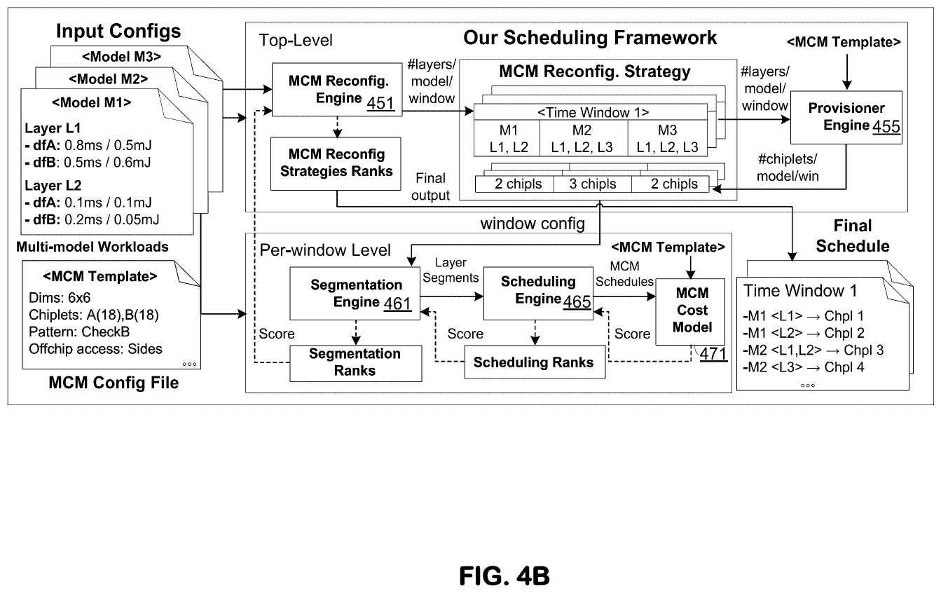

To address the challenges and search complexity, one approach is to formulate the problem as a multi-level decision problem where each decision subspace is a tractable problem. We adopt a similar approach and formulate the MCM multi-model workload scheduling as multiple-level decision problem, as shown in FIG. 4A. FIG. 4A graphically illustrates a two-level workload scheduling method disclosed herein. A top-level search (first level or level one) produces layer segmentation that is provided as input to per-window search (second level or level two). Detail of problem formulation and performance modeling methodology are presented in following sections.

### Systems and Methods for Scheduling Multi-Model AI Workloads

Emerging multi-model workloads with heavy models like recent large language models significantly increased the compute and memory demands on hardware. To address such increasing demands, designing a scalable hardware architecture became a key problem. Among recent solutions, the 2.5D silicon interpose multi-chip module (MCM)-based AI accelerator has been actively explored as a promising scalable solution due to their significant benefits in the low engineering cost and composability. However, previous MCM accelerators are based on homogeneous architectures with fixed dataflow, which encounter major challenges from highly heterogeneous multi-model workloads due to their limited workload adaptivity.

Therefore, in this work, the technology disclosed provides the opportunity in the heterogeneous dataflow MCM AI accelerators. We identify the scheduling of multi-model workload on heterogeneous dataflow MCM AI accelerator is an important and challenging problem due to its significance and scale, which reaches O(10⁵⁶) scale even for a two-model workload on 6×6 chiplets. The technology disclosed comprises a set of heuristics to navigate the huge scheduling space and codify them into a scheduler (also referred to as a scheduling engine or SCAR) with advanced techniques such as inter-chiplet pipelining. A n evaluation of the technology disclosed is provided on ten multi-model workload scenarios datacenter multitenancy and AR/VR use-cases. This evaluation has shown the efficacy of the technology disclosed, achieving on average 27.6% and 29.6% less energy-delay product (EDP) for the respective applications settings compared to homogeneous baselines.

### System Modeling and Problem Formulation

To develop a systematic approach to navigate complex search space, a formulation of the scheduling problem of multi-model workloads on a heterogeneous MCM AI accelerator is presented below. FIG. 3 presents a table (labeled as Table I) that presents notation and corresponding description for use in the system modeling and problem formulation disclosed herein.

### A. Base Formulation

To formulate the MCM scheduling problem, we first define multi-model workload scenario (Sc) and MCM hardware (H). We formulate the workload in the granularity of layers in each model. Therefore, we formulate a multi-model workload scenario (Sc) as the collection of layers in the models included in the scenario. Letting the number of models included in Sc as |Sc| and the number of layers included in a model m as ml, we define Sc as follows:

Definition 1. Multi-Model Workload Scenario (Sc)

Sc={layeri,j|0<i≤|Sc|, 0<j≤|mi|} where layer(i,j) refers to the j-th layer of model i in Sc. AI accelerator chiplets consist of a PE array, memory, and on-chip interconnection among memory and PEs. In addition to them, we also include the dataflow in the formulation to model heterogeneous chiplet MCM AI accelerator. Accordingly, we define an AI accelerator chiplet (c) as follows:

Definition 2. AI Accelerator Chiplet (c)

$$c = df , {N}_{P E} , B W noc , B W mem , Szmem \}$$

In Definition 2, df refers to the dataflow, N_{PE} is the number of PEs, BW noc is the NoC bandwidth, BW mem is the chiplet-level shared memory bandwidth, and Szmem is the memory size in c.

Based on the definition of the chiplet, we formulate the MCM accelerator as the set of chiplets (C={c1, c2, . . . , cN cpl}), NoP, and off-chip interface as follows:

Definition 3. MCM AI Accelerator (H)

$$H = \{ C , B {W}_{offchip} , B {W}_{nop} \}$$

Unless otherwise stated, we assume the 2D mesh topology for NoP like Simba, and chiplets on two sides (left and right) of the packages have off-chip interfaces.

### B. Workload Partitioning Space

To reduce the complexity of the scheduling problem, we adopt a multi-level scheduling method, which splits the end-to-end workload defined in the layer granularity into coarse-grained layer groups, termed as the time window. FIG. 4A shows an example of the time window that contains six layers from Model A and five layers from Model B.

A time window (tw) is defined by the start time and the duration (TS and Ttw) and a set of assigned layers to the time window, as shown in Definition 4.

Definition 4. Time Window (tw), for a target workload scenario Sc, a time window tw is defined as follows:

$$tw ( Sc ) = ( {T}_{s ,} {T}_{t w} , L )$$

$$where$$

$$L = \{ I \vert I ∈ S c \}$$

The time window describes a set of layers to be executed on an MCM AI accelerator package, which is used for describing package level scheduling. For each chiplet, we define a finer-grained group of layers within a time window. We term the sub-set of layers within a time window as “segment”.

Definition 5. Segment (sg), for a time window tw(Sc) and its layers L(tw(Sc)), the segment sg(tw(Sc)) is defined as follows:

$$sg ( tw ( Sc ) ) = \{ I \vert I ∈ L ( tw ( Sc ) ) \}$$

To develop a systematic optimization algorithm for layer segmentation i each time window, we need to define the conditions of valid layer segments, provided as follows:

Theorem 1. The validity of segments in a time window For a time window tw(Sc) and its layers L(tw(Sc)), let the set of all segments for tw(Sc) be SG, then SG is valid if the following condition is satisfied:

$${U}_{sg ∈ 5 S} sg = L ( tw ( Sc ) ) ⋀ [ ∀ {sg}_{i} / = {sg}_{i} ∈ SG , {sg}_{i} ∩ {sg}_{j} = ∅ ]$$

Theorem 1 states two conditions (1) the set of segments needs to cover all the layers in their time window for completing assigned layer computations for the time window and (2) all segments are exclusive to prevent redundant computing. The same idea extends to the time window as follows:

Theorem 2. The validity of time window partitioning

For a multi-model workload Sc, its layers L(Sc), and the set of time windows TW (Sc), TW (Sc) is valid if the following condition is satisfied:

$${U}_{tw ∈ TW ( Sc )} t w = L ( Sc ) ⋀ [ ∀ {tw}_{i} / - {tw}_{j} ∈ TW ( Sc ) , {tw}_{i} ∩ {tw}_{j} = ∅ ]$$

Both Theorem 1 and Theorem 2 indicate that the segments and time windows need to be partitions of the workload and time window layers, respectively. Combining all definitions in this section, we formulate the workload partitioning space into the time window and segment as follows:

Definition 6. Workload Partitioning Space

For a multi-model workload Sc, the time window partitioning space (Sptw(Sc)) and the layer segmentation space for a time window (Sp_{sg}(tw)) are defined as follows:

$$Sptw ( Sc ) = P ( L ( Sc ) )$$

$${Sp}_{s g} ( t w ) = P ( L ( tw ) )$$

where P(A) refers to all possible partitioning of a set A.

### C. Scheduling Space

A segment contains layers to be executed on a chiplet. Therefore, spatial (i.e., which segment runs on which chiplet) and temporal mappings (i.e., execution order of segments on each chiplet) of segments construct the scheduling space within each time window when segments are determined. The scheduling space within a time window tw(Sc) can be defined as follows:

Definition 7. Scheduling Space in a Time Window (SS_{TW}) For a given time window tw(Sc) and a target MCM accelerator hardware H, the scheduling space within the time window (SS_{TW}(tw(Sc), H) is defined as follows:

$${SS}_{TW} ( tw ( Sc ) , SG , H ) = \{ ( sg , c , j ) \vert sg ∈ SG ⋀ c ∈ {C}_{H} ⋀ j ∈ N ⋀ val ( sg , tw ( Sc ) ) \}$$

where C_{H} refers to the set of chiplets in H and val(sg,tw(Sc)) indicates the validity of sg for tw(Sc)

Each entry in SS_{TW} describes the spatial and temporal mapping of a segment (sg). Spatial mapping can be defined as the target chiplet to execute sg. Accordingly, a target chiplet (c) is specified for sg. The temporal mapping is defined as the execution order. Therefore, a natural number j is used to represent the execution order. Note that the execution order is defined separately on each chiplet. Based on Definition 7, we can define the entire scheduling space as the collection of that in each time window.

Definition 8. MCM Scheduling Space for a Multi-model Workload (SS_{Sc}(H))

For an MCM AI accelerator (H) and a multi-model workload (Sc), the scheduling space (SS_{Sc}(H)) is defined as follows:

$${SS}_{Sc} ( H ) = \{ ( TW , {SG}_{TW} , ( {SS}_{TW} ( tw , {SG}_{TW} ( tw ) , H ) ) \vert TW ⊂ {Sp}_{tw} ( Sc ) ⋀ {SG}_{TW} ( tw ) ⊂ {Sp}_{sg} ( tw ) ⋀ tw ∈ TW \}$$

where SG_{TW} refers to the set of layer segments for each time window in TW. Definition 8 defines the entire scheduling space of an MCM AI accelerator for a multi-model workload as the cross-product of all possible time window partitioning, layer segmentation for each time window, and corresponding scheduling space within each time window.

### D. Scheduling Problem

Based on Definition 8, we define a schedule instance as the collection of spatial and temporal mapping for given valid time windows (TW) and segments for each time window (SG_{TW}).

### Definition 9. MCM Schedule

A schedule instance (sched(Sc, H)) is defined as follows:

$$sched ( Sc , TW , {SG}_{TW} , H ) = \{ ( TW , {SG}_{TW} , s ) \vert valid ( TW , Sc ) ⋀ ∀ tw ∈ TW : val ( {SG}_{TW} ( tw ) , tw ) ⋀ s ∈ {SS}_{TW} ( tw , {SG}_{TW} ( tw ) , H ) \}$$

where SG_{TW} refers to the set of layer segments for each time window in TW. Using Definition 9, we formulate the scheduling problem as a minimization problem of an optimization metric of choice (e.g., latency and energy), as follows:

Definition 10. MCM Scheduling Problem

$$arg {min}_{TW , {SG}_{TW} , Sched} OptMetric ( TW , SGTW , Sched , H ) where Sched = sched ( Sc , TW , {SG}_{TW} , H )$$

The optimization metric can be chosen by users depending on the use case. The disclosed scheduler (also referred to as the scheduling engine), incorporates a comprehensive and customizable score that thoroughly considers all of latency, energy, and energy-delay product (EDP), allowing users to configure their own optimization metrics, which can be the mentioned frequently used metrics, or a user-defined function that takes a schedule instance and generates a custom metric.

### E. Performance Modeling

In order to evaluate schedules on target MCM AI accelerator hardware, we extend MAESTRO, (for further detail see, Kwon et al., 2019, “Understanding Reuse, Performance, and Hardware Cost of DNN Dataflow: A Data-Centric Approach,” published in proceedings of 52^{nd} IEEE/ACM International Symposium on Microarchitecture, pp. 754-768), to the chiplet domain and model the latency experienced on MCM AI accelerators when concurrently executing multi-model workloads. The following section discusses latency evaluation methodology in detail.

Layer Latency. The latency incurred by an individual layer, I, mapped onto an accelerator chiplet is defined as:

$$Lat ( l ) = {Lat}^{ip comp} ( l ) + {Lat}^{comp} ( l ) + {Lat}^{op com} ( l )$$

Lat^{comp}(I) is the layer computation cost dependent on chiplet parameters in Definition 2; Lat^{ipcom}(I) is latency incurred from loading the layer operands (input activations and weights); Lat^{op com}(I) is transmission latency of output activation to a subsequent layer. Lat^{com} is defined as:

$${Lat}^{com} = \{ \begin{matrix}0 , if same chiplet \\ \frac{Szdata}{BWnop} + {n}_{{h}_{0} ps} \times {Lath}_{0} ps + δ if same package \\ \frac{Szdata}{BWmem} + nhops \times Latmem + Latmem + δ if offhcip\end{matrix}$$

where communication costs are incurred when transmitting data to/from another chiplet on package or the offchip memory. The first term

$$\frac{Szdata}{BW}$$

reflects transmission latency; the second term captures propagation latency across nₕₒₚₛ between the source and destination; δ is an additional latency term for potential NoP traffic conflicts; Latₘₑₘ is the offchip memory read/write latency based on memory bandwidth.

Time Window Latency. We first model a layer segment's latency in a time window as follows:

$$Lat ( sg ) = {\sum }_{n = 1}^{N} {Lat}^{comp} ( {I}_{n} ) + {Lat}^{ip \_ comp} ( sg ) + {Lat}^{op com} ( sg )$$

The first term represents the sum of individual layer computational latencies; Lat^{ip_com} is the initial external off-chiplet data transfer to load inputs and weights; Lat^{op com} is the transmission latency from transmitting segment output data to the next segment or offchip memory. From here, we can define the time window latency as:

$$Lat ( tw ) = \frac{max}{SGmCSG} [ Lat ( {SG}_{m} ) ]$$

Where for a time window's assigned set of segments, SG, the overall window latency is the maximum latency incurred by a subset of segments, SGm∈SG, associated with a model m and necessitating sequential execution. Lat(SGm) can be estimated as the pipelining latency across segments, that is, given model m requires processing data with batch size, b and the max number of samples any chiplet can process at a time is given by mini-batch size, b′<=b, we get:

$$Lat ( {SG}_{m} ) = {\sum }_{sgk ∈ SGm} Lat ( sgk \vert b ’ ) + ( \frac{b}{b ′} - 1 ) \times {max}_{sgk} [ Lat ( {sg}_{k} \vert b ’ ) ]$$

Overall Latency. The overall Scenario latency can then be estimated as the aggregate across all time windows:

$$Lat ( Sc ) = {\sum }_{twj ∈ TW} Lat ( {tw}_{j} )$$

Energy Modeling. Albeit similar to latency, energy costs are always aggregated considering communication energy costs of data sizes, nₕₒₚₛ bit transmission energy, and memory access.

### Proposed Scheduling Framework: Scar

We discuss our scheduling framework, SCAR, for multi-model workloads on heterogeneous MCMs based on the hierarchical search space characterization and problem formulation presented above. As illustrated in FIG. 4A, the disclosed scheduling method (or scheduling algorithm) is a two-level approach comprising top-level and per-window searches. Top-level search comprises logic for selecting layers in each model to be scheduled within a time window and determining the initial number of chiplet nodes for each model. Per-window search comprises logic for the spatial and temporal partitioning (tiles or layer segments) of the layers in each model at the chiplet granularity. To explore the chiplet granularity tiling space, the technology disclosed comprises logic to generate valid inter-chiplet-pipelined schedules utilizing a scheduling tree structure inspired by the RA Tree. Each schedule is evaluated using the disclosed custom heterogeneous MCM cost model which provides feedback to the chiplet level tiling (labeled as “layer segmentation” in FIG. 4A) with expected metrics (latency, energy, EDP, etc.).

FIG. 4B presents codification of the proposed scheduling method or scheduling algorithm into a scheduling framework. As inputs, the disclosed scheduling framework receives (1) description files of the multi-model workloads (layer parameters, topology, dependencies, etc.) and (2) a description file of the MCM hardware specification (the number of chiplets, the shape, and chiplet arrays dataflow organization, network-on-package (or NoP) bandwidth, on-chiplet memory size, etc.). As outputs, the disclosed scheduling framework outputs an optimized schedule with expected metrics such as latency, energy, EDP, or other user-defined metrics as a combination of latency and energy. The proposed scheduling framework consists of four processing engines (also referred to as processing components or software engines) as illustrated in FIG. 4B. The logic implemented by each processing engine is presented below.

### A. MCM Reconfiguration Engine (MCM-Reconfig)

The MCM-Reconfig. Engine (labeled as 451 in FIG. 4B) at the top-level step receives the multi-model workload descriptions with layer information in each model, layer dependency, and expected latency and energy of each layer on each chiplet class offline-analyzed by MAESTRO. The MCM-Reconfig. engine (also referred to as MCM-Reconfiguration engine) 451 is responsible for the window assignment in FIG. 4A, which (1) generates candidate time window partitioning strategies via sampling a set of discrete points in time as boundary points, and (2) assigns layers from models to each time window. As the final assignment of layers to chiplets is not known apriori, the decisions in MCM-Reconfig engine are based on expected execution times. Formally, given |DF| dataflow style classes, the expected execution latency for a layer I is:

$$E ( Lat ( l ) ) = {\sum }_{i = 1}^{\vert DF \vert} \frac{ndfi}{\vert C \vert} \times Lat ( l \to i ) \qquad Equation ( 1 )$$

where ndfi indicates the number of class i chiplets integrated onto the MCM having |C| chiplets in total; Lat1→| is layer I latency when scheduled on the class i chiplet, which is retrieved offline from latency database generated by MAESTRO. The average execution time information is utilized in MCM-Reconfig engine for window assignment process illustrated in FIG. 4B.

Time Windows Characterization. MCM-Reconfig. engine (labeled as 451 in FIG. 4B) first specifies the number of windows, through a hyperparameter, nₛₚₗᵢₜₛ, to explore proper cut points for each model. For example, in FIG. 4A, the model A has a cut after layer 6, which led to having layers 1-6 in Window 1. The worst-case latency experienced by any model is set as the time horizon to be partitioned into periodic time windows.

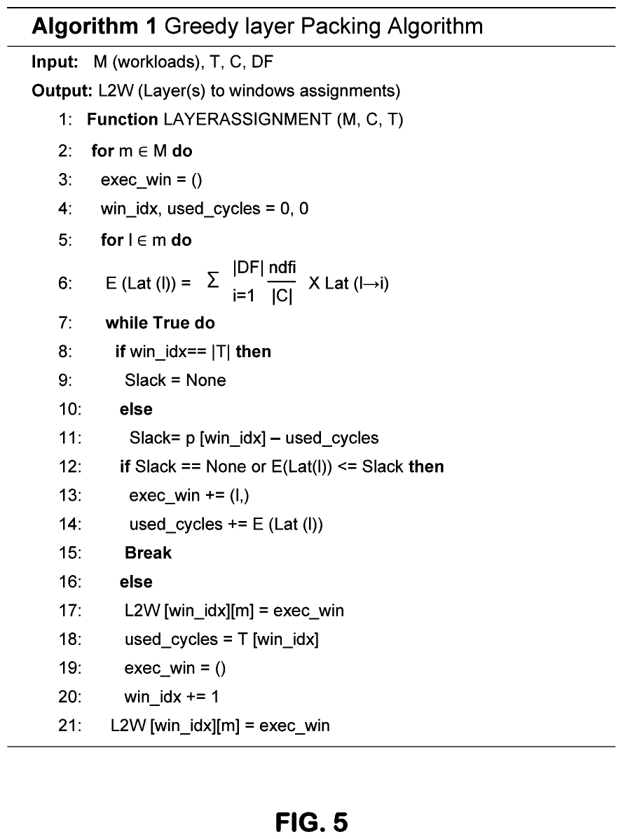

Greedy Layer Packing Algorithm. We adopt a first-fit greedy-packing heuristic to assign layers to execution time windows if their execution time is expected to finish within the time window boundaries (see Algorithm 1 in FIG. 5). Any layer whose execution time lies across two time windows is deferred to the next time window. This approach enables the following:
(i) running low-latency layers in earlier windows (restricts starvation).
(ii) dynamically controlling the number of time windows by skipping trivial time windows with no workloads. Based on our analysis of the periodic window characterization with greedy layer packing using a workload of UNet and GPT2-L against a layer-optimal approach. It was found that rate of EDP improvement stagnated after 4 splits. We set nₛₚₗᵢₜₛ=4 (5 time windows) as our default unless otherwise stated.

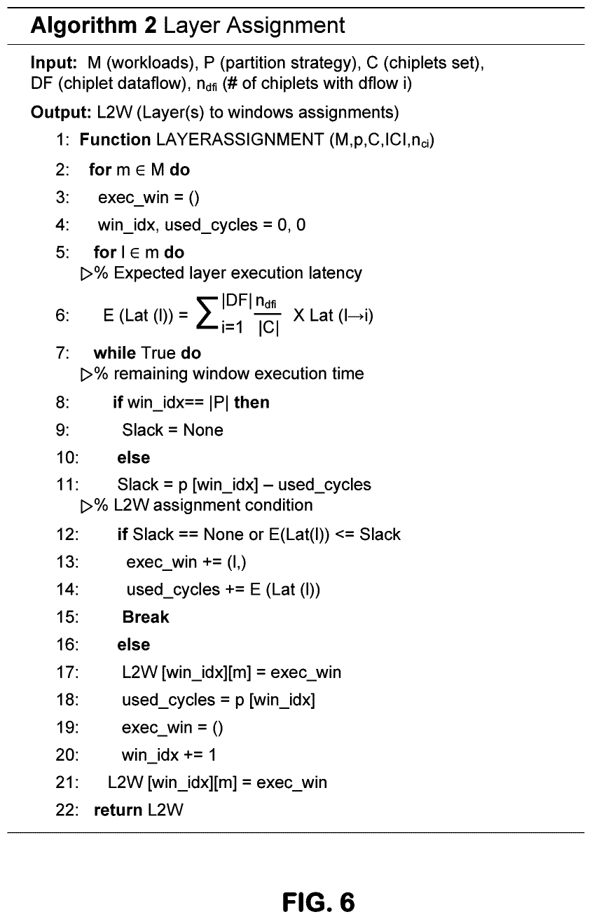

FIG. 6 presents another implementation of the layer assignment algorithm labeled as Algorithm 2. Multi-model workload introduces a challenge: the time window boundary determined by the cut points of one model might not be aligned with other models. Therefore, we adopt a first-fit heuristic where layers are assigned to an execution window if their execution time is expected to be within a time window (see Algorithm 2 in FIG. 6). Even if the start and finish time is not aligned with those of a time window. Any layer with execution time lies across two-time windows is deferred to the next time window. This approach not only solves the time window—layer execution time misalignment problem, but also facilitates to run low latency layers that prevents starvation of small workloads blocked by heavy workloads.

### B. Provisioner Engine (PROV)

The PROV (or provisioner) engine (455 in FIG. 4B) outputs an initial estimate on the number of chiplet needed by each model workload in every time window from a candidate partitioning strategy. PROV assignments are agnostic to the underlying chiplets' properties (dataflow, resources), and hence we refer to chiplets in this state as nodes. The technology disclosed implements the PROV engine 455 to support exhaustive search or rule-based node distribution assignments. A uniform distribution rule allocates Ni nodes to the ith model as follows:

$${N}_{i} = round ( \frac{E ( {P}_{i} )}{{\sum }_{j} E ( {P}_{i} )} \times \vert C \vert )$$

where E(Pᵢ) represents the expected value of a target performance optimization metric (latency, energy, EDP) for the model i. E(Pᵢ) is computed in a manner similar to the expectation formula in Equation (1).

The technology disclosed ensures every model in the time window is assigned at least one node to progress its execution. The rules enable trading off search complexity for coverage. We analyze the efficacy of the uniform distribution compared to the exhaustive search further.

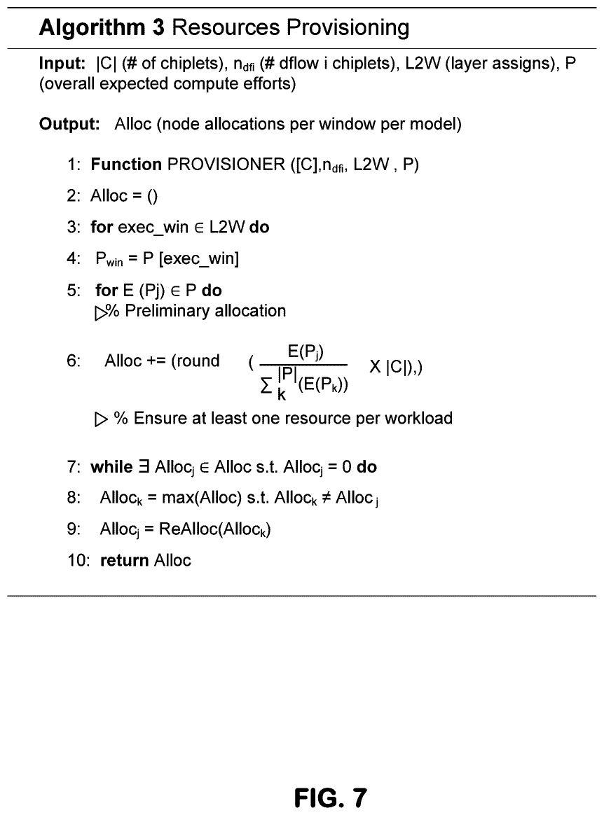

To ensure the progression of all model workloads assigned to a window, we enforce the allocation of at least one resource per model per window. This addresses corner cases in which a model workload assigned to the window has negligible expected computational overhead compared to its peers, leading its expectation formula in (10) to evaluate to 0. The reallocation process iteratively reassigns nodes from models with max number of resources until the constraint is satisfied. For further details, see Algorithm 3, presented in FIG. 7.

### C. Segmentation Engine (SEG)

The SEG (or segmentation) engine (labeled as 461 in FIG. 4B) is instantiated every time window to partition topologically sorted model layers into layer segments (Definition 5) that are mappable to computing nodes for exclusive execution throughout the time window. Different segmentation choices reflect various trade-off points between the layer-sequencing and layer-pipelining features: the former concerns with execution locality on the same node; the latter specifies inter-layer and inter-chiplet pipelining opportunities.

Segmentation Search Space. A segmentation candidate is represented by a sequence of splitting points. Candidate splitting points for a model can be specified after each layer provided to the SEG. Given |Lᵢ| and |Nᵢ| as the respective number of layers and number of assigned nodes from the PROV to model workload mi, the max number of segments that can be generated for mi is upper bounded by Nᵢ.

Thus, the overall segmentation space complexity becomes

$$O ( {\prod }_{i} ( \begin{matrix}{L}_{i} \\ {N}_{i - 1}\end{matrix} ) ) ,$$

We incorporate the following heuristics to manage complexity.

Heuristic 1. Product to summation reduction. The technology disclosed reduces complexity by leveraging the independence of segments from different models to divide the search into a two-step process (1) SEG engine first evaluates segmentation candidates from each model separately. (2) The top-k segmentation candidates from each model are used to construct a smaller combinatorial seg-mentation search space used in the final evaluation. Through this heuristic, the search space complexity is reduced from

$$O ( {\prod }_{i} ( \begin{matrix}{L}_{i} \\ {N}_{i - 1}\end{matrix} ) ) to O ( max ( \begin{matrix}{L}_{i} \\ {N}_{i - 1}\end{matrix} ) ) .$$

Heuristic 2. Node allocation constraint. To further reduce the search complexity within the SEG engine, SCAR supports having a node allocation constraint as a hyperparameter, particularly beneficial in cases where time windows have model workloads with dissimilar layer distributions (e.g., one model with a heavy layer, another with numerous small layers), which could lead to an explosion in the number of trivial segmentation options from the low-cost layers, causing the SEG search space complexity to rise. As such small layers are more suited for continuous execution on the same resource by virtue of their lower computational footprints, and to limit unnecessary, costly inter-chiplet data movements, we designate a node allocation constraint to enable alleviating this added complexity by restricting the number of nodes assigned to workloads with disproportionately large number of layers.

### D. Scheduling Engine (SCHED)

The innermost SCHED (or scheduling) engine (labeled as 465 in FIG. 4B) is responsible for generating the actual physical mapping of layer segments onto chiplets.

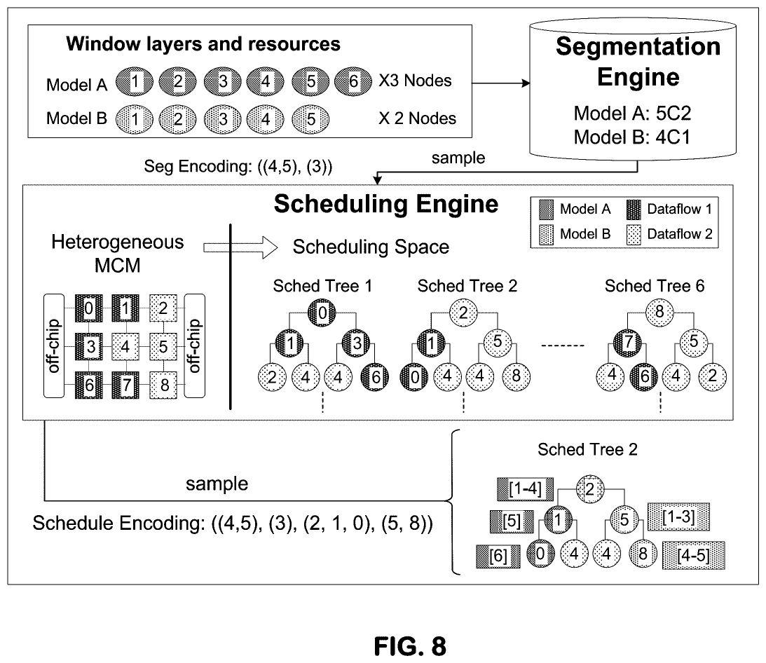

SCHED Search Space: As illustrated in FIG. 8, the scheduling search space for the mapping of M model workloads onto C chiplets is represented by a forest of scheduling trees. We define (i) forest; as the entire collection of search trees. (ii) tree; a single scheduling tree with all models. (iii) subtree; a subset tree exclusively associated with a model.

Scheduling Tree Composition: Every node in a scheduling tree corresponds to a unique chiplet resource on the MCM showcasing its distinctive heterogeneous features (i.e., dataflow). Tree edges are constructed based on each chiplet's neighbors connected directly through an interposer. Though a node j can be replicated throughout the tree, it can only be visited once, indicating its exclusive occupancy by a model.

Trees Distinction: Within each tree, the root nodes of the subtrees specify different chiplets as potential starting positions for candidate model schedules (see FIG. 8). Thus, the scheduling space coverage starts by selecting a tree, represented by a permutation sequence of subtrees' root nodes—e.g., permutation sequence [i,j,k] indicates exploring scheduling candidates for a tree with scheduling candidates starting at chiplet positions i, j, and k for a 3-model workload. The depth of model i's subtree is determined by Nᵢ.

Candidate Schedules Generation: Through traversing each subtree, we can obtain candidate execution schedules for each model by assigning segments orderly to the subtree's nodes. Starting from the root node of the first model's subtree, a constrained depth first search (DFS) is performed generating a candidate schedule path once the full subtree depth (Nᵢ) is reached. This traversal is repeated for each subsequent subtree, constrained on the preceding subtree's prior visited nodes.

Encoding and Search Algorithm: As shown in FIG. 8, the scheduling engine uses a 2×|M|-length tuple to represent the final scheduling encoding, where the first M entries reflect segmentation decisions for each model mi, and the latter |M| entries reflect schedule mappings of segments to chiplets for each workload. This encoding enables various search strategies (e.g., evolutionary).

Search Space Complexity: Given |M| as the number of models in a given window, |T| the number of scheduling trees in the search space, d is a traversal path's degree of freedom, and Nₘₐₓ representing the max number of resources allocated to any model in this window. The scheduling search complexity can be given by O(|M|×|T|×d^{Nmax})

### E. Cost Model and Scoring

The technology disclosed implements a cost model for evaluating scheduling candidates on different performance efficiency metrics.

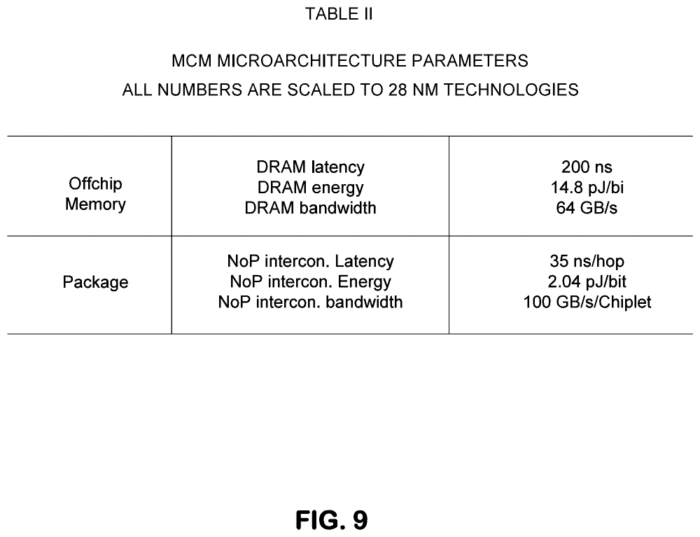

Cost Model. We build our analytical cost model (471 in FIG. 4B) on top of MAESTRO, which is a standardized analytical cost model tool for modeling performance of AI operators' mappings (dataflow and tiling) on AI accelerators, with a reported 96% accuracy of performance estimation compared to low-level RTL simulation. MAESTRO natively enables intra-chiplet performance modeling, and we extend it for the MCM AI accelerator setting by integrating the MCM design parameters from Simba as shown in a table in FIG. 9, where we add MCM-specific layers upon MAESTRO leveraging its proven communication overhead modeling methodology to model offchip and inter-chiplet communication costs. The overall cost model follows the performance models as described above. The table in FIG. 9, labeled as Table II presents MCM microarchitecture parameters. The numbers presented in the table in FIG. 9 are scaled to 28 NM technology. The MCM parameters as shown in the table in FIG. 9 are adapted from O renes-Vera et al., 2023, “Massive data-centric parallelism in the chiplet era,” available at <<arxiv.org/abs/2304.09389>> and Shao et al., 2019, “Simba: Scaling deep-learning inference with multi-chip-module-based architecture,” published in proceedings of the 52nd Annual IEEE/ACM International Symposium on Microarchitecture.

Scoring: Scores are estimated based on latency, energy, or EDP metrics following the characterization as presented above. The SCHED aggregates scores for each model's schedule, and returns the top performing configuration to the SEG engine to rank segmentation strategies. Top segmentation strategies in each window are aggregated to score the overall scheduling strategy at MCM-Reconfig (see scoring flow in broken lines in FIG. 4B).

### EVALUATION

### A. Experimental Settings

Multi-Model Workloads. The evaluations are performed on multi-model workload scenarios based on models from (1) MLPerf inference benchmark, which are curated for datacenter multi-tenancy setting following data center usage trends in. (2) XR Bench for multi-model AR/VR workloads. The full list of scenarios is provided in a table in FIG. 10. These scenarios cover a wide range of use-cases with varying degrees of diversity and complexity.

MCM System. The technology disclosed (also referred to as SCAR) is evaluated on a variety of MCM systems following Simba architecture. Simba comprises a total of 36 chiplets arranged as four 3×3 groups of chiplets and connected in a Mesh topology. We implement (1) 3×3, and (2) 6×6 MCM templates for our experiments. XY routing is adopted (or used) for on-package data movement, and integrates further memory interfaces on the sides of the outer chiplets for direct access to the offchip DRAM. For the experiments, 4096 PEs/chiplet and 256 PEs/chiplet for the datacenter and AR/VR settings, are considered, respectively. L2 shared memory size is set in each chiplet to 10 MB as in a recent mobile accelerator's on-chip memory size.

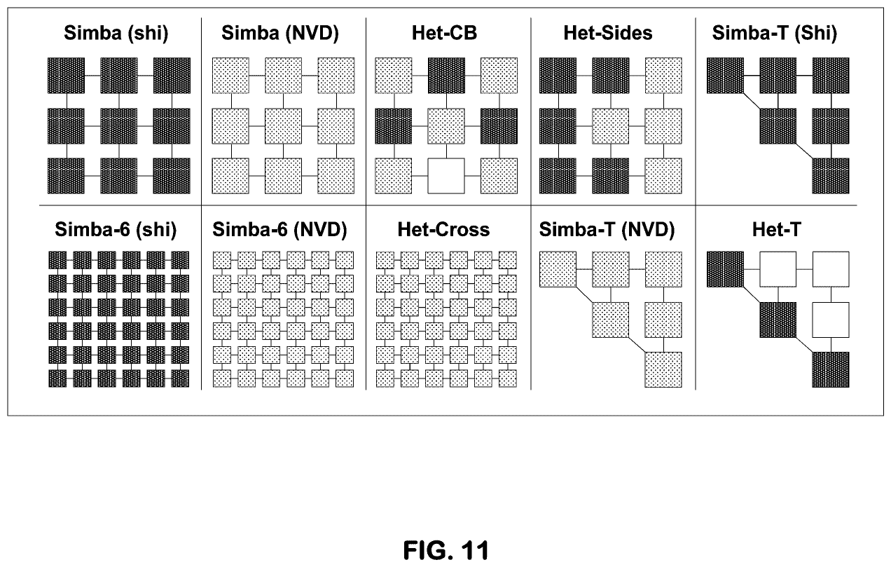

Baselines and MCM patterns: Shidiannao and NVDLA dataflow styles are chosen for our accelerator chiplets given their proven superiority and adopt two baselines:
Standalone. each model is assigned a single accelerator chiplet—all chiplets adopt the same dataflow.
Simba-like Pipelining. In each time window, model work-loads can be assigned to more than one chiplet. All chiplets adopt the same dataflow. FIG. 11 illustrates the MCM chiplet patterns evaluated using the scheduling technology disclosed herein (also referred to as SCAR). The 3×3 MCM patterns are the default.

Optimization Targets. Search space exploration experiments are performed to target optimizing a single metric at a time, coining the terms Latency Search, Energy Search, and EDP Search. EDP Search is our default experiment.

Search Criteria. An exhaustive brute-force search is used for all 3×3 MCM experiments. For the 6×6 experiment, we implement an evolutionary algorithm for the SEG module to navigate the rising complexity. The population size and max number of generations are set to 10 and 4, respectively.

### B. Datacenter Multi-Model Scheduling Results

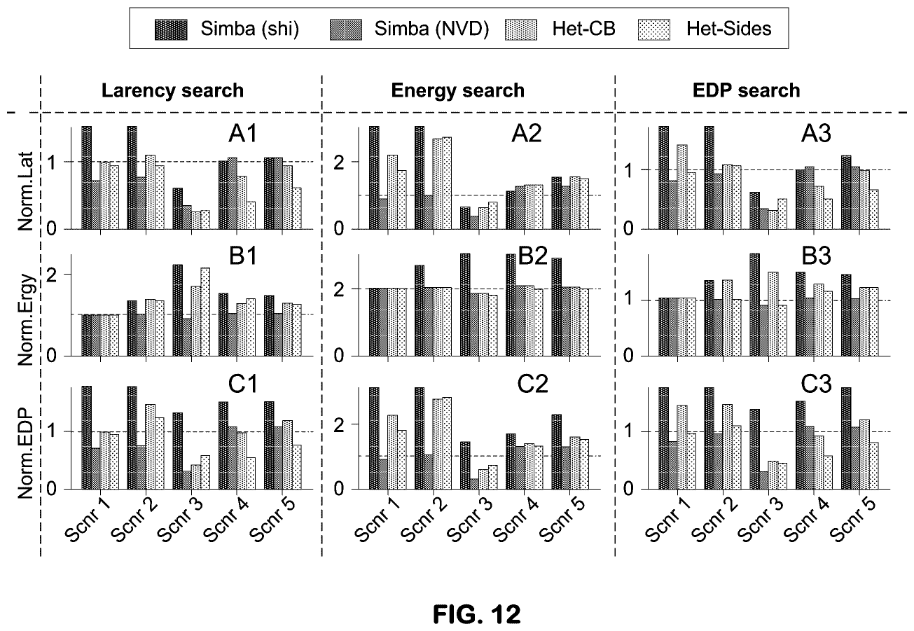

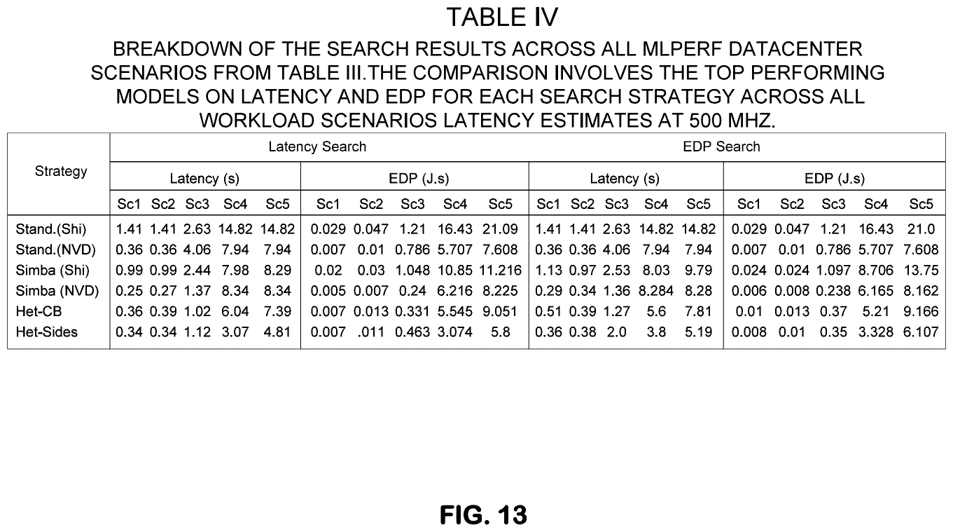

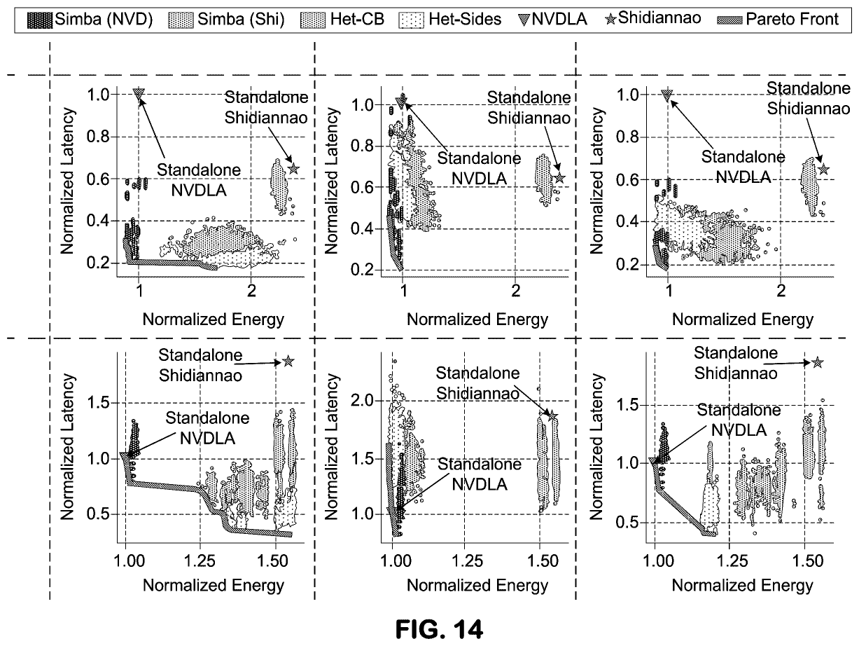

We discuss the full datacenter scheduling results on the 3×3 MCM, provided in a table in FIG. 13 and graphically illustrated in FIG. 12. FIG. 14 illustrates the Pareto search results for Scenarios 3 and 4 listed as Sc3 and Sc4 in the table in FIG. 13. FIG. 13 presents a table labeled as Table IV. The table in FIG. 13 presents a breakdown of the search results across all datacenter scenarios from the table in FIG. 10. The comparison in the table in FIG. 13 involves the top performing models on latency and EDP for each search strategy across all workload scenarios.

Impact of Workload Scenarios. It is observed that different scenarios are more affine towards different MCM strategies owing to their varying degrees of diversity and computational demands within the multi-model suite. For example in the EDP search presented in the table in FIG. 13, shows scenarios 1-3 that favor the standalone (NVD) and Simba (NVD) strategies as both are dominated by low-batched, transformer-based workloads (GPT-L and BERT-L) characterized by strong affinities towards the NVDLA dataflow style. As the computational load and model diversity increase, schedules obtained through heterogeneous strategies become more favorable. For instance in the EDP search scenarios 4-5 (in FIG. 13) with more batches and heavy ResNet-50 and UNet workloads, Het-Sides outperforms all other strategies on EDP evaluation, experiencing 46.02% and 25.18% less EDP compared to Simba (NVD) on the respective scenarios.

Target Objective Impact: The bar plots in FIG. 12 present latency, energy and EDP evaluations for top-scoring 3×3 candidates normalized by the standalone NVDLA for datacenter scenarios. Bar plots labeled A1, B2 and C3 present main results (aligned optimization and evaluation metric). In matching criteria plots (labeled A1, B2, and C3) in FIG. 12, Het-Sides schedules for the heaviest scenarios 4-5 outperform schedules from all other strategies. This superiority, however, comes at the expense of other metrics. For instance, in graphical plot C3, the Het-Sides schedule outperforms that from all other strategies by experiencing 0.58× the EDP from the Standalone (NVD). This is achieved, however, by speeding up execution at the expense of energy consumption, where Het-Sides achieves the fastest execution speedup of 2× over Standalone (NVD) in (A3) at the expense of being 1.22× more energy demanding than Standalone (NVD) in (B3).

Pipelining Benefits and NoP impact: Pipelining individually can offer performance improvements over standalone baselines when ample resources are available to the models. For example, Scenario 3 (Latency Search)—top-left most Pareto results graph in FIG. 14 shows Simba (NVD) schedules achieving considerable speedups over the standalone NVDLA baseline (2.9×for the top-performing candidate from table in FIG. 13). The reason being that as the scheduler targets latency optimization, it attempts to consistently identify chiplet assignment strategies that equate pipelining latencies between model workloads as-signed to the same time window. For instance, in the last time window containing ResNet-50, the Simba (NVD) scheduler for Scenario 3 queued 18, 14, and 29 layers from the GPT-L, BERT-L, and ResNet-50 for processing, provisioned 3 chiplets for each subset, and yielded accordingly 3 layer segments per model. This configuration led to the model workloads achieving comparable inter-chiplet pipelining latencies of 0.28 ms, 0.32, and 0.33 ms, eventually leading the full schedule to sustain a total of 1.37 s latency compared to the 4.06 s from the standalone NVDLA. We also observe that keeping medium-sized data traffic on package through chiplet-to-chiplet data passing contributes additional energy savings for these medium sized workloads by decreasing offchip memory read/write accesses at the segments' start and end times. For the NoP traffic, FIG. 12, graphical plot A1 summarizes our findings. In Scenarios 1-3, Simba (NVD) leverages inter-chiplet pipelining to outweigh added NoP costs, achieving latency speedups over standalone NVDLA reaching 1.4×, 1.3×, and 2.9×, respectively. In Scenarios 4-5, Simba (NVD) to incur 1.05× slowdown from the added traffic in both scenarios.

Heterogeneity Benefits. Heterogeneous integration patterns compensate for the added NoP traffic in the heavier workloads (Scenarios 4-5) and boost efficiency through considering per layer dataflow affinities. Het-Sides achieves 1.7× and 1.25×EDP efficiency over the standalone (NVD). We find also that Het-Sides is always superior to Het-CB in such heavy scenarios as it offers opportunities for both homogeneous and heterogeneous inter-chiplet pipelining. This is beneficial for batched layer sequences with same dataflow affinities.

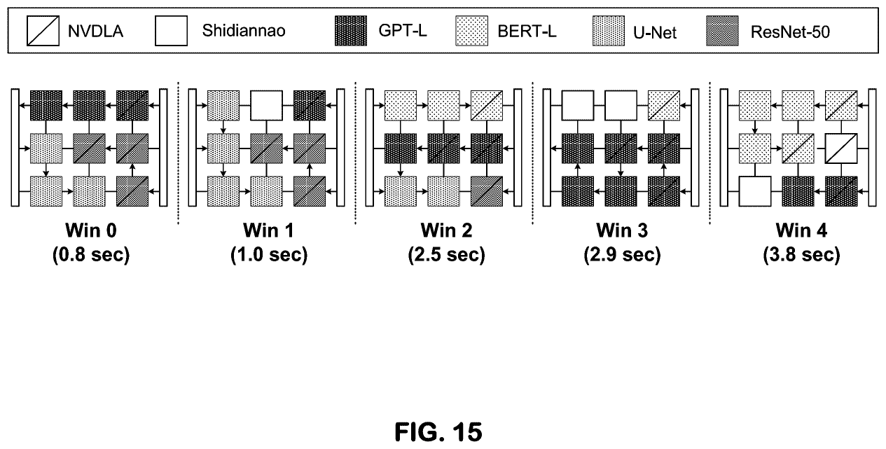

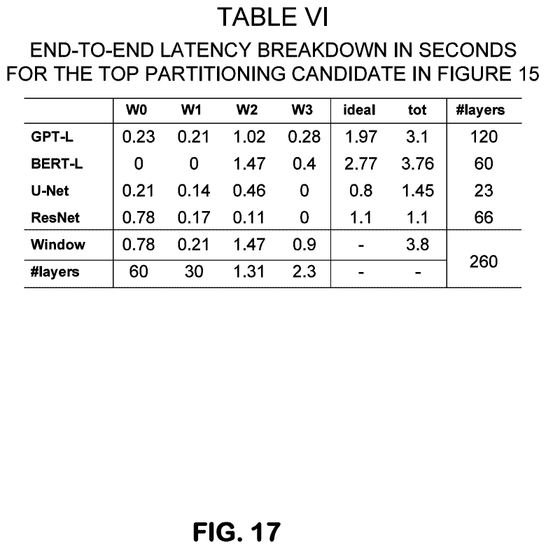

Het-Sides Top Schedule: In FIG. 15, we illustrate the top-scoring Het-Sides schedule from the EDP search in Scenario 4. Allocation of chiplets and coarse-grained schedules are shown for each time window. Times computed over 500 MHz indicate cumulative window latencies. As shown, the greedy-packing algorithm leads to non-uniform windows where smaller workloads (ResNet-50) are assigned to the earlier windows at the expense of larger workloads (BERT-L). This facilitates (i) fine grained optimization of small workload schedules; (ii) avoiding small workloads starvation. GPT-L and BERT workloads dominate the schedule from window 2. A table in FIG. 17 (labeled as Table VI) breaks down the latency in each window. The table in FIG. 17 presents the end-to-end latency breakdown in seconds for the top partitioning candidate in FIG. 15.

### C. AR/VR Multi-Model Scheduling Results

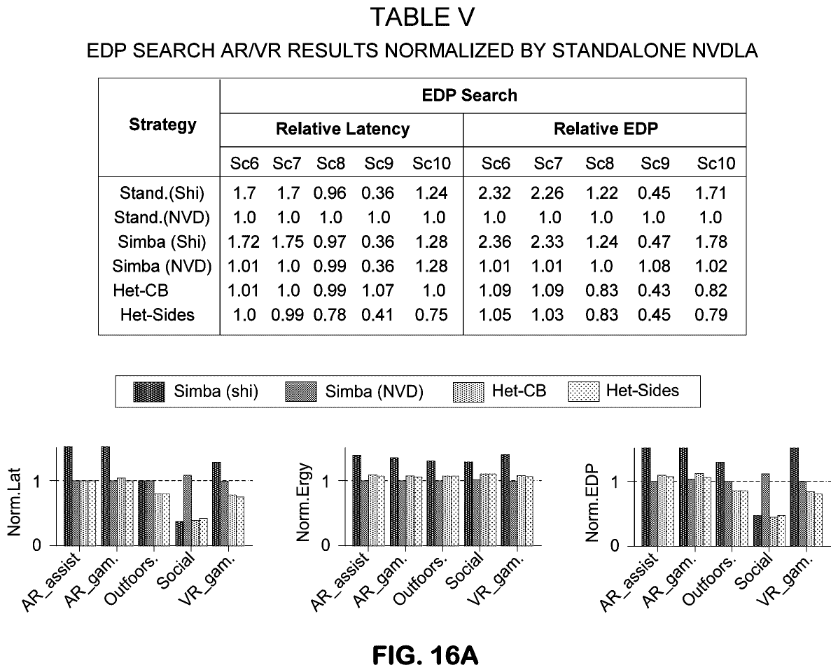

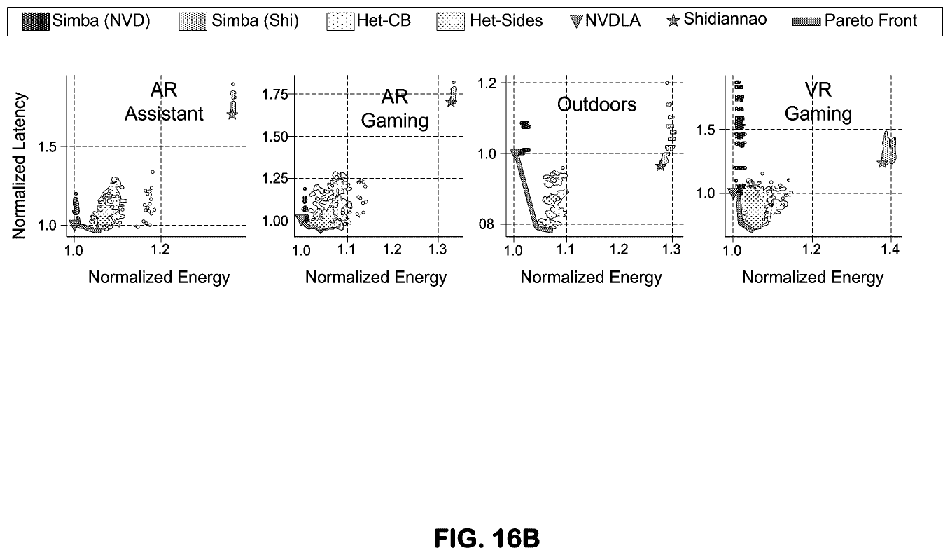

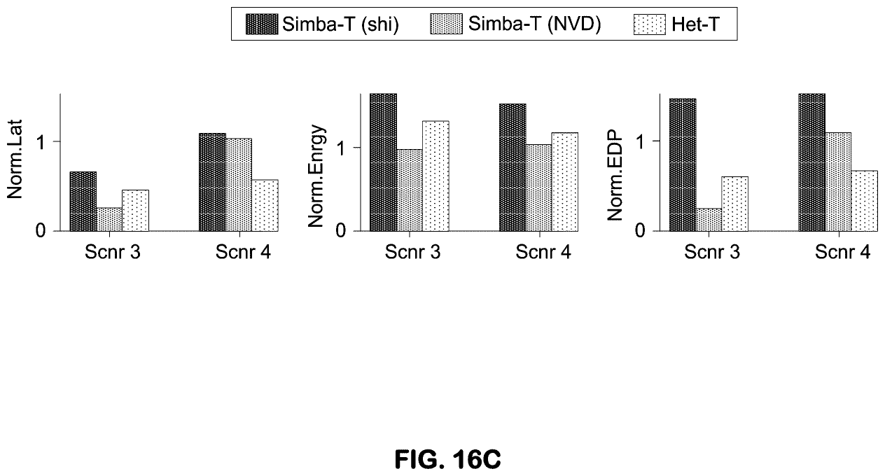

The AR/VR scheduling results on the EDP search for the 3×3 MCM are provided in a table and graphical plots presented in FIG. 16A. The table in FIG. 16A is labeled as Table V and presents EDP search AR/VR results normalized by standalone NVDLA. The graphical plots in FIG. 16A include evaluations on the EDP search for the XR Bench usage scenarios listed in a table presented in FIG. 3, normalized by NVDLA standalone configuration. Graphical plots in FIG. 16B presents graphs illustrating the Pareto optimal results on the EDP search experiments for the labeled XR Bench usage scenarios. The results are normalized by standalone NVDLA. On average, the Het-Sides schedule achieves 17% and 21.3% EDP improvement over standalone NVDLA and Simba (NVD), respectively. We also find that the smaller MCM system limits improvement potential for the heaviest scenarios, AR assistant (scenario 6) and AR gaming (scenario 7) due to increased resource contention, leading the heterogeneous and NVDLA based schedules to achieve comparable evaluations (see graphical plots in FIG. 16A).

D. Scaling to 6×6 MCM system

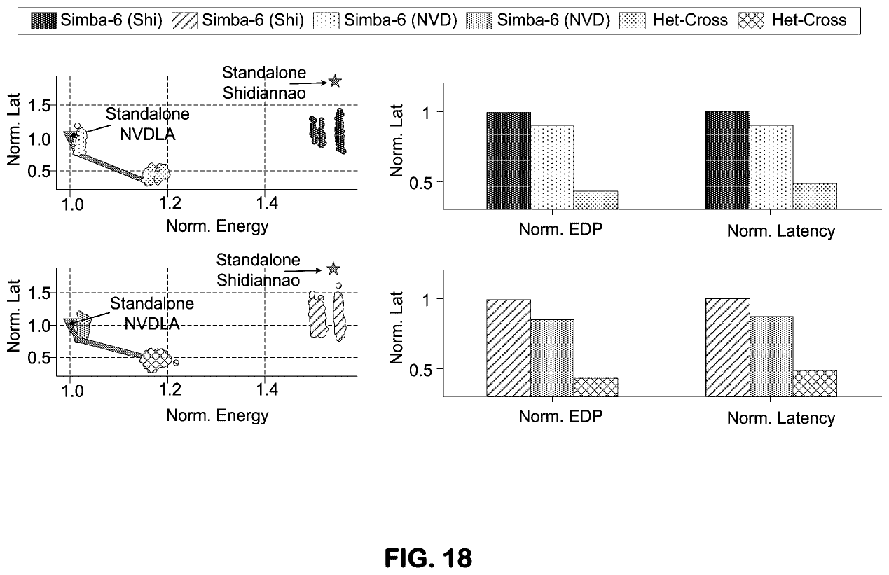

We assess how the technology disclosed (also referred to as SCAR scheduling) scales with the hardware using the 6×6 full Simba MCM system with its templates from FIG. 11. An evolutionary algorithm is implemented for the SEG engine to scale with the rising problem size, and show the results for the EDP search on Scenario 4 at nₛₚₗᵢₜₛ=2 and nₛₚₗᵢₜₛ=3. We choose the heterogeneous cross (Het-Cross) as our heterogeneous template following the insights from the 3×3 experiment regarding choosing heterogeneity patterns that enable both homogeneous and heterogeneous pipelining capabilities. FIG. 18 shows Pareto plot and comparison of top performing models for the EDP search on the 6×6 MCM at nₛₚₗᵢₜₛ=2(top) and nₛₚₗᵢₜₛ=3 (bot). As shown in FIG. 18, the evolutionary search has led to identifying configurations for Het-Cross that achieve 2.3× and 1.9× reduction in EDP; 2.1× and 1.8× reduction in latency over Simba (Shi) and Simba (NVD), respectively.

### E. Ablation Studies

Ablation Study on Time Partitioning: Using Scenario 4 and Het-Sides strategy, we study how performance changes when varying nₛₚₗᵢₜₛ from 1 to 5 and repeating the EDP search experiment. Prior to nₛₚₗᵢₜₛ=4, the average rate of reduction in EDP was 1.25×. The rate of improvement drops to only 1.04× between nₛₚₗᵢₜₛ=4 to 5, indicating diminishing returns.

Ablation Study on other NoP Topology: The technology disclosed (also referred to as SCAR) can generalize to other NoP topologies as it relies on adjacency matrix connectivity. We test this by performing the EDP search for Scenarios 3 and 4 using the triangular NoP topologies in FIG. 11. FIG. 16C present graphical plots illustrating results for EDP search for scenarios 3 and 4 on the triangular NoP topologies from FIG. 11 (normalized by standalone NVDLA). As shown in FIG. 16C, similar performance patterns are exhibited compared to the Scenario results on the 3×3 Mesh, albeit with varying relative gains. For instance, though Het-T outperforms both Simba-T strategies in Scenario 4 by 2.5× and 1.67× over Simba-T (Shi) and Simba-T (NVD), respectively, it is second best compared to Simba-T (NVD) in Scenario 3 by a factor of 2.5× (compared to 1.47× from FIG. 12, graphical plot C3) due to the increased competition for resources.

Ablation Study on rule-based PROV: We repeated the EDP search for all strategies across Scenarios 3-5 on the 3×3 template using an exhaustive search over the Ni values. Though the results improved further with the added search complexity, the insights remained the same. For Scenarios 4-5, Het-Sides remained superior, achieving respective EDP reductions of 38.3% and 29.9% from Standalone NVDLA; 59.5% and 57.6% from Simba (Shi); 33.0% and 28.3% from Simba (NVD). For Scenario 3, Simba (NVD) remained superior, achieving 79.7% EDP reduction Het-Sides. These evaluations follow the trends from our rule-based results shown in a table in FIG. 13.

Ablation on Greedy Packing Algorithm: Using Scenario 4 and Het-Sides, we test the efficacy of our first-fit greedy layer packing algorithm against a uniform packing baseline, distributing layers uniformly across time windows. Ours achieved 21.8% speedup and 8.6% energy reduction.

### F. Summary of Results and Main Insights

We summarize our main insights and findings as follows.
Heterogeneous MCM patterns improve performance for heavy and diverse multi-model workloads (scenarios 4-5).
Homogeneous MCM patterns are more suited for small multi-model workloads (scenarios 1-3).
Heterogeneous MCM patterns with diverse pipelining options (Het-Sides) are superior to heterogeneous patterns with homogeneous pipelining options (Het-CB).
The target optimization objective is crucial in identifying the best integration strategy. In EDP search scenario 4, Het-sides outperformed all other strategies on EDP, but not on pure energy consumption.
Topology and number of resources affect the extent of performance improvement for heterogeneous strategies.

Our findings show that understanding multi-model workload characteristics and usage scenarios is crucial for identifying the best MCM integration strategy for a target objective.

### Discussion

Multi-model optimization targets. We experimented with different optimization targets (latency, EDP, energy) for our scenarios, and showed that the top performing strategy can change based on the target objective. As multi-model work-loads evolve, it may be desirable to assign separate optimization targets for different models within a scenario (EDP v. lat). One practical way to achieve this in our framework is by adding a constraint in our EDP search, invalidating schedules that have certain models violate a latency constraint (i.e., the EDP search becomes lower bounded by the latency search).

Heterogeneous chiplets technology. Heterogeneous chiplet integration has become a viable, cost-effective approach to design state-of-the-art AI systems. Nvidia's world-class super-chips are a successful example of heterogeneous on-package integration (e.g., Grace-Blackwell (1 CPU+2 GPUs)). The success of these systems and others (AMD's MI300X [1]) is testament to the hardware manufacturers' investment in chiplets technology, where through advanced manufacturing processes and heterogeneous integration capabilities, the development of MCM AI accelerators (like Nvidia's Simba) becomes more accessible, allowing chiplet modifications/replacement in MCM hardware at lower costs without requiring a complete overhaul of the entire package.

Scheduler Software Integration. The technology disclosed (also referred to as SCAR) can be integrated on top of existing compiler infrastructure. The advanced scheduling techniques supported by the scheduler (dynamic chiplet regrouping, inter-chiplet pipelining) represent high-level abstractions of the computational graphs that can be transformed through standard compiler software (e.g., MLIR) to representations suited for the underlying hardware. For example, dynamic chiplets regrouping is correspondent to graph partitioning, where a model's computational graph is divided into smaller subgraphs, each associated with the set of computing nodes assigned during the corresponding time window. The subgraphs can then be transformed to lower representations covering the details of buffer management, die-to-die communication, memory R/W requests, I/O, all the way to the transformations covering the dataflow features (loop reordering, spatial unrolling) for the specialized accelerators.

Comparison with Other Technologies

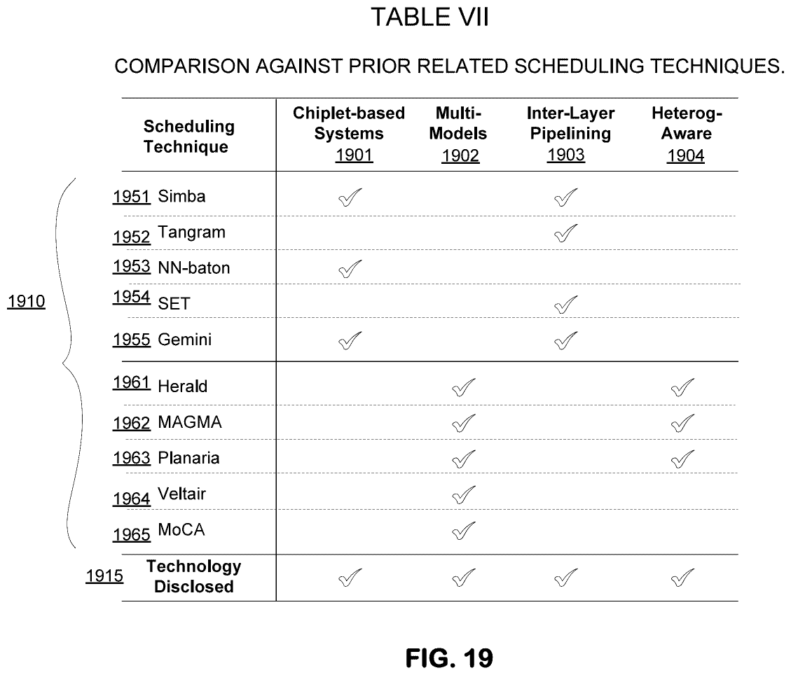

Scheduler for Accelerators. A table shown in FIG. 19 presents a comparison of the scheduling technology (1915) disclosed herein against prior scheduling techniques (1910) using four criteria listed in column 1901, 1902, 1903 and 1904. As shown, the prior scheduling techniques (1910) can be categorized into two groups. The first group of techniques comprises scheduling technique that have considered aspects of inter-layer pipelining and chiplet-based systems. Examples of these techniques are labeled as 1951, 1952, 1953, 1954 and 1955 on FIG. 19. The second group of techniques comprises scheduling techniques that focused on multi-model workloads on heterogeneous platforms. Examples of such techniques are labeled as 1961, 1962, 1963, 1964 and 1965 in FIG. 19. It can be seen that only the scheduling technology disclosed herein addresses all four aspects i.e., MCM, multi-model workloads, inter-layer pipelining, and heterogeneous dataflow. Therefore, the technology disclosed (1951) provides a comprehensive scheduling technique by supporting all four evaluation criteria listed as columns 1901, 1902, 1903 and 1904 in table VII in FIG. 19.

Multi-chiplet Modules. Several works proposed to address the scalability challenge for DNN acceleration via MCM integration. Most notably, Simba pioneered a scalable deep learning MCM inference accelerator leveraging non-uniform work partitioning, communication-aware data placement, and cross-layer pipelining.

Intra- and Inter-layer Parallelism. Prior works explored intra-layer parallelism to maximize DNN performance efficiency by partitioning DNN layers into smaller, parallelizable tiles. Other works studied the inter-layer scheduling space to compensate for workloads with low degrees of parallelism.

### CONCLUSION

A discussion is presented describing the scheduling space of a new class of MCM accelerator architecture, heterogeneous MCM AI accelerator, targeting multi-model AI workloads. We identify that the scheduling problem is intractably large but multi-level problem formulation and heuristics we proposed are effective for the large-scale scheduling problem. The results (as presented above) also show that heterogeneous MCM accelerator is beneficial for multi-model workloads, which motivates further exploration.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:

1. A scheduling framework for multi-model workloads on heterogeneous chiplet-based multi-chip modules, comprising:
a top-level search executed by a reconfiguration engine configured with a window assignment logic that, based on expected execution latencies of layers in the multi-model workloads, generates candidate time window partitioning strategies by sampling a set of discrete points in time reflecting boundary points between execution windows, and assigns the layers in the multi-model workloads to corresponding ones of the execution windows;
a rule-based provisioning logic configured to provide an initial estimate on a number of chiplet nodes needed by each model workload in each execution window given a candidate partitioning strategy;
a per-window search executed by a segmentation engine configured to spatially and/or temporally partition the layers into smaller segments of layers, where each of the segments are mappable to a chiplet for exclusive execution throughout a duration of an execution window;
a scheduling logic configured to generate a final mapping of layer segments to physical chiplets on the heterogeneous chiplet-based multi-chip modules; and
a cost modeling logic configured to produce as output an optimized schedule with expected metrics.

2. The scheduling framework of clause 1, wherein the multi-model workloads correspond to workloads of multiple artificial intelligence models, wherein each of the multiple artificial intelligence models has a plurality of layers.

3. The scheduling framework of clause 2, wherein description files of the multi-model workloads specify at least one of layer parameters, a layer topology, layer dependencies, and an expected latency and energy of each layer on each chiplet as analyzed offline.

4. The scheduling framework of clause 1, wherein description files of hardware specification of the heterogeneous chiplet-based multi-chip modules specify at least one of a number of chiplets, a shape of chiplet arrays, a dataflow organization of the chiplet arrays, network-on-package (NoP) bandwidth, and on-chiplet memory size.

5. The scheduling framework of clause 1, wherein the expected execution latencies of the layers are estimated using average latency for each chiplet type with a unique dataflow organization in the heterogeneous chiplet-based multi-chip modules.

6. The scheduling framework of clause 1, wherein the window assignment logic assigns the layers to corresponding ones of the execution windows based on a first-fit heuristic.

7. The scheduling framework of clause 1, wherein rules used by the rule-based provisioning logic are based on expected latency, energy, and energy-delay product (EDP).

8. The scheduling framework of clause 7, wherein the rules are based on user-defined metric for each corresponding execution window.

9. The scheduling framework of clause 1, wherein the rule-based provisioning logic warrants a fair spatial distribution of the chiplet nodes per execution window across the model workloads.

10. The scheduling framework of clause 1, wherein the rule-based provisioning logic is agnostic to a dataflow of underlying chiplets in the heterogeneous chiplet-based multi-chip modules.

11. The scheduling framework of clause 1, wherein the smaller segments of layers are segments.

12. The scheduling framework of clause 1, wherein the smaller segments of layers are tiles.

13. The scheduling framework of clause 1, wherein the segments are executable in a layer-sequential manner that executes a particular segment's sequence of layers on an allocated chiplet.

14. The scheduling framework of clause 1, wherein the segments are executable in a layer-pipelining that executes inter-layer and inter-chiplet pipelining between different segments conditioned on their dependencies.

15. The scheduling framework of clause 1, wherein the scheduling logic further configured to generate the final mapping based on exploring a scheduling search space that encapsulates scheduling candidates capturing true physical properties of the heterogeneous chiplet-based multi-chip modules.

16. The scheduling framework of clause 15, wherein the true physical properties include at least one of heterogeneity pattern, offchip memory access, and NoP topology.

17. The scheduling framework of clause 1, wherein the expected metrics include latency, energy, or EDP.

18. The scheduling framework of clause 17, wherein the expected metrics are user-defined metrics based on a combination of latency and energy.

19. A method for scheduling multi-model workloads on heterogeneous chiplet-based multi-chip modules, the method including:
performing a top-level search and generating candidate time window partitioning strategies, based on expected execution latencies of layers in the multi-model workloads, by sampling a set of discrete points in time reflecting boundary points between execution windows,
assigning the layers in the multi-model workloads to corresponding ones of the execution windows;
providing an initial estimate on a number of chiplet nodes needed by each model workload in each execution window given a candidate partitioning strategy using a rule-based provisioning logic;
performing a per-window search to spatially and/or temporally partition the layers into smaller segments of layers, wherein each of the segments are mappable to a chiplet for exclusive execution throughout a duration of an execution window;
generating a final mapping of layer segments to physical chiplets on the heterogeneous chiplet-based multi-chip modules; and producing, as output, using a cost model, an optimized schedule with expected metrics.

20. A non-transitory computer readable storage medium impressed with computer program instructions to schedule multi-model workloads on heterogeneous chiplet-based multi-chip modules, the instructions, when executed on a processor, implement a method, of a server node, comprising:
performing a top-level search and generating candidate time window partitioning strategies, based on expected execution latencies of layers in the multi-model workloads, by sampling a set of discrete points in time reflecting boundary points between execution windows,
assigning the layers in the multi-model workloads to corresponding ones of the execution windows;
providing an initial estimate on a number of chiplet nodes needed by each model workload in each execution window given a candidate partitioning strategy using a rule-based provisioning logic;
performing a per-window search to spatially and/or temporally partition the layers into smaller segments of layers, wherein each of the segments are mappable to a chiplet for exclusive execution throughout a duration of an execution window;
generating a final mapping of layer segments to physical chiplets on the heterogeneous chiplet-based multi-chip modules; and producing, as output, using a cost model, an optimized schedule with expected metrics.

### Computer System

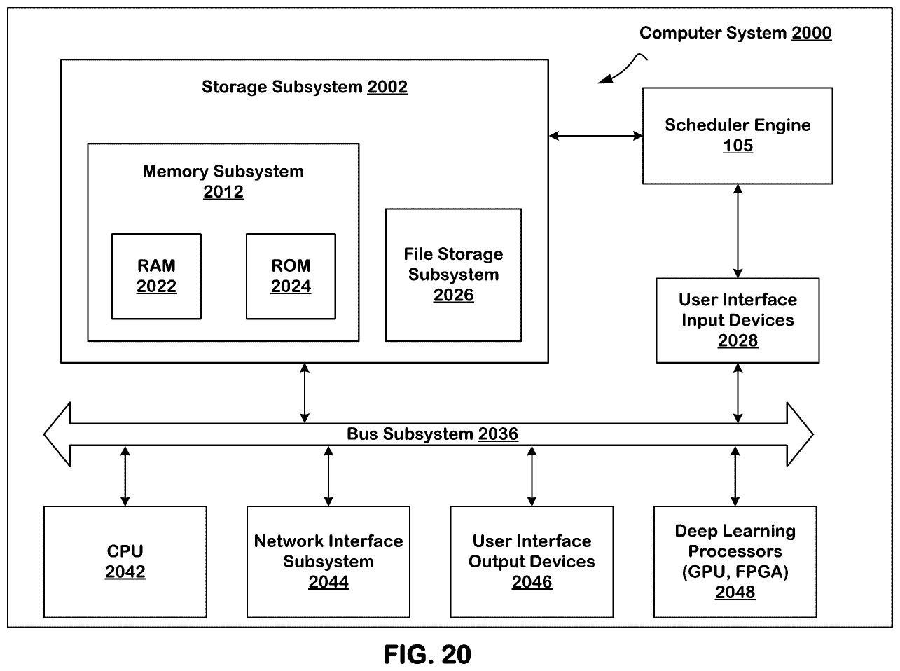

FIG. 20 shows an example computer system (also referred to as a computing node) 2000 that can be used to implement the technology disclosed. Computer system 2000 includes at least one central processing unit (CPU) 2042 that communicates with a number of peripheral devices via bus subsystem 2036. These peripheral devices can include a storage subsystem 2002 including, for example, memory devices and a file storage subsystem 2026, user interface input devices 2028, user interface output devices 2046, and a network interface subsystem 2044. The input and output devices allow user interaction with computer system 2000. Network interface subsystem 2044 provides an interface to outside networks, including an interface to corresponding interface devices in other computer systems.

In one implementation, the scheduling framework is communicably linked to the storage subsystem 2002 and the user interface input devices 2028.

User interface input devices 2028 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2000.

User interface output devices 2046 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2000 to the user or to another machine or computer system.

Storage subsystem 2002 stores programming and data constructs that provide the functionality of some or all of the modules and methods described herein. These software modules are generally executed by processors 2048.

Processors 2048 can be graphics processing units (GPUs), field-programmable gate arrays (FPGAs), application-specific integrated circuits (ASICs), and/or coarse-grained reconfigurable architectures (CGRAs). Processors 2048 can be hosted by a deep learning cloud platform such as Google Cloud Platform™, Xilinx™, and Cirrascale™. Examples of processors 2048 include Google's Tensor Processing Unit (TPU)™, rackmount solutions like GX4 Rackmount Series™, GX17 Rackmount Series™, NVIDIA DGX-1™, Microsoft' Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100S™, and others.

Memory subsystem 2012 used in the storage subsystem 2002 can include a number of memories including a main random access memory (RAM) 2022 for storage of instructions and data during program execution and a read only memory (ROM) 2024 in which fixed instructions are stored. A file storage subsystem 2026 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2026 in the storage subsystem 2002, or in other machines accessible by the processor.

Bus subsystem 2036 provides a mechanism for letting the various components and subsystems of computer system 2000 communicate with each other as intended. Although bus subsystem 2036 is shown schematically as a single bus, alternative implementations of the bus subsystem can use multiple busses.

Computer system 2000 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 2000 depicted in FIG. 20 is intended only as a specific example for purposes of illustrating the preferred implementations of the present technology disclosed. M any other configurations of computer system 2000 are possible having more or less components than the computer system depicted in FIG. 20.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 20 is a schematic of an exemplary computing node. The computer system (also referred to as a computing node) 2000 is only one example of a suitable computing node and is not intended to suggest any limitation as to the scope of use or functionality of embodiments described herein. Regardless, computing node 2000 is capable of being implemented and/or performing any of the functionality set forth hereinabove.

In the computing node 2000 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 20, computer system/server in computing node 2000 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A scheduling framework for multi-model workloads on heterogeneous chiplet-based multi-chip modules, comprising:
a top-level search executed by a reconfiguration engine configured with a window assignment logic that, based on expected execution latencies of layers in the multi-model workloads, generates candidate time window partitioning strategies by sampling a set of discrete points in time reflecting boundary points between execution windows, and assigns the layers in the multi-model workloads to corresponding ones of the execution windows;
a rule-based provisioning logic configured to provide an initial estimate on a number of chiplet nodes needed by each model workload in each execution window given a candidate partitioning strategy;
a per-window search executed by a segmentation engine configured to spatially and temporally partition the layers into smaller segments of layers, wherein each of the smaller segments is mappable to a chiplet for exclusive execution throughout a duration of an execution window;
a scheduling logic configured to generate a final mapping of layer segments to physical chiplets on the heterogeneous chiplet-based multi-chip modules; and
a cost modeling logic configured to produce as output an optimized schedule with expected metrics.

2. The scheduling framework of claim 1, wherein the multi-model workloads correspond to workloads of multiple artificial intelligence models, wherein each of the multiple artificial intelligence models has a plurality of layers.

3. The scheduling framework of claim 2, wherein description files of the multi-model workloads specify at least one of layer parameters, a layer topology, layer dependencies, and an expected latency and energy of each layer on each chiplet as analyzed offline.

4. The scheduling framework of claim 1, wherein description files of hardware specification of the heterogeneous chiplet-based multi-chip modules specify at least one of a number of chiplets, a shape of chiplet arrays, a dataflow organization of the chiplet arrays, network-on-package (NoP) bandwidth, and on-chiplet memory size.

5. The scheduling framework of claim 1, wherein the expected execution latencies of the layers are estimated using average latency for each chiplet type with a unique dataflow organization in the heterogeneous chiplet-based multi-chip modules.

6. The scheduling framework of claim 1, wherein the window assignment logic assigns the layers to corresponding ones of the execution windows based on a first-fit heuristic.

7. The scheduling framework of claim 1, wherein rules used by the rule-based provisioning logic are based on expected latency, energy, and energy-delay product (EDP).

8. The scheduling framework of claim 7, wherein the rules are based on user-defined metric for each corresponding execution window.

9. The scheduling framework of claim 1, wherein the rule-based provisioning logic warrants a fair spatial distribution of the chiplet nodes per execution window across the multi-model workloads.

10. The scheduling framework of claim 1, wherein the rule-based provisioning logic is agnostic to a dataflow of underlying chiplets in the heterogeneous chiplet-based multi-chip modules.

11. The scheduling framework of claim 1, wherein the smaller segments of layers are segments.

12. The scheduling framework of claim 1, wherein the smaller segments of layers are tiles.

13. The scheduling framework of claim 1, wherein segments in the smaller segments are executable in a layer-sequential manner that executes a particular segment's sequence of layers on an allocated chiplet.

14. The scheduling framework of claim 1, wherein segments in the smaller segments are executable in a layer-pipelining that executes inter-layer and inter-chiplet pipelining between different segments conditioned on their dependencies.

15. The scheduling framework of claim 1, wherein the scheduling logic further configured to generate the final mapping based on exploring a scheduling search space that encapsulates scheduling candidates capturing true physical properties of the heterogeneous chiplet-based multi-chip modules.

16. The scheduling framework of claim 15, wherein the true physical properties include at least one of heterogeneity pattern, offchip memory access, and NoP topology.

17. The scheduling framework of claim 1, wherein the expected metrics include latency, energy, or EDP.

18. The scheduling framework of claim 17, wherein the expected metrics are user-defined metrics based on a combination of latency and energy.

19. A method for scheduling multi-model workloads on heterogeneous chiplet-based multi-chip modules, the method including:
performing a top-level search and generating candidate time window partitioning strategies, based on expected execution latencies of layers in the multi-model workloads, by sampling a set of discrete points in time reflecting boundary points between execution windows;
assigning the layers in the multi-model workloads to corresponding ones of the execution windows;
providing an initial estimate on a number of chiplet nodes needed by each model workload in each execution window given a candidate partitioning strategy using a rule-based provisioning logic;
performing a per-window search to spatially and temporally partition the layers into smaller segments of layers, wherein each of the smaller segments is mappable to a chiplet for exclusive execution throughout a duration of an execution window;
generating a final mapping of layer segments to physical chiplets on the heterogeneous chiplet-based multi-chip modules; and
producing, as output, using a cost model, an optimized schedule with expected metrics.

20. A non-transitory computer readable storage medium impressed with computer program instructions to schedule multi-model workloads on heterogeneous chiplet-based multi-chip modules, the instructions, when executed on a processor, implement a method, of a server node, comprising:
performing a top-level search and generating candidate time window partitioning strategies, based on expected execution latencies of layers in the multi-model workloads, by sampling a set of discrete points in time reflecting boundary points between execution windows;
assigning the layers in the multi-model workloads to corresponding ones of the execution windows;
providing an initial estimate on a number of chiplet nodes needed by each model workload in each execution window given a candidate partitioning strategy using a rule-based provisioning logic;
performing a per-window search to spatially and temporally partition the layers into smaller segments of layers, wherein each of the smaller segments is mappable to a chiplet for exclusive execution throughout a duration of an execution window;
generating a final mapping of layer segments to physical chiplets on the heterogeneous chiplet-based multi-chip modules; and
producing, as output, using a cost model, an optimized schedule with expected metrics.
